(19) United States
(12) Patent Application Publication
(10) Pub. No.: US 2022/0386599 A1
(43) Pub. Date: Dec. 8, 2022

(54) METHOD FOR CONTROLLING VOLUNTEER CORN IN CULTIVATION OF DICOT CROPS

(71) Applicant: SUMITOMO CHEMICAL COMPANY, LIMITED, Chuo-ku (JP)

(72) Inventor: Yoshinao SADA, Kasai-shi (JP)

(73) Assignee: SUMITOMO CHEMICAL COMPANY, LIMITED, Chuo-ku (JP)

(21) Appl. No.: 17/775,784

(22) PCT Filed: Nov. 27, 2019
(86) PCT No.: PCT/JP2019/046391

§ 371 Date: May 10, 2022

(51) Int. Cl. A01N 35/10; A01P 13/02; A01N 43/84; A01N 43/54; A01N 37/28; A01N 37/40

(52) U.S. Cl. CPC A01N 35/10; A01P 13/02; A01N 43/84; A01N 43/54; A01N 37/28; A01N 37/40

(57) ABSTRACT

Provided is a method for controlling volunteer corn plants tolerant to protoporphyrinogen oxidase (PPO) inhibiting herbicides in a cultivation area of a dicot crop, including a step of applying an Acetyl-CoA carboxylase (ACCase) inhibiting herbicide to the corn plants.

### TECHNICAL FIELD

The present invention relates to a method for controlling volunteer corn in a cultivation of dicot crops.

### BACKGROUND ART

Volunteer corn is a problem in a cultivation of dicot crops. PPO tolerant crops are known in various patent applications (see patent Documents 1 to 16).

### CITATION LIST

### Patent Literature

PTL 1: U.S. Pat. No. 6,239,072 B1

PTL 2: U.S. Pat. No. 8,748,700 B2

PTL 3: WO 2011/085221 pamphlet

PTL 4: WO 2012/080975 pamphlet

PTL 5: WO 2014/030090 pamphlet

PTL 6: WO 2015/022640 pamphlet

PTL 7: WO 2015/022636 pamphlet

PTL 8: WO 2015/022639 pamphlet

PTL 9: WO 2015/092706 pamphlet

PTL 10: WO 2016/203377 pamphlet

PTL 11: WO 2017/198859 pamphlet

PTL 12: WO 2018/019860 pamphlet

PTL 13: WO 2017/112589 pamphlet

PTL 14: WO 2017/039969 pamphlet

PTL 15: WO 2017/023778 pamphlet

PTL 16: WO 2018/022777 pamphlet

PTL 17: WO 2018/114759 pamphlet

PTL 18: WO 2019/118726 pamphlet

### SUMMARY OF INVENTION

### Technical Problem

An object of the present invention is to provide an excellently effective method for controlling volunteer corn plants tolerant to protoporphyrinogen oxidase (PPO) inhibiting herbicides in a cultivation area of dicot crops. An object of the present invention is further to provide an excellently effective method for controlling the corn plants in a cultivation area of dicot crops, wherein the dicot crops are also tolerant to PPO inhibiting herbicides.

### Solution to Problem

The present invention relates to a method for controlling volunteer corn plants tolerant to protoporphyrinogen oxidase (PPO) inhibiting herbicides in a cultivation area of dicot crops, comprising a step of applying an Acetyl-CoA carboxylase (ACCase) inhibiting herbicide to the corn plants.

The present invention includes the followings.

[1] A method for controlling volunteer corn plants tolerant to protoporphyrinogen oxidase (PPO) inhibiting herbicides in a cultivation area of a dicot crop, comprising a step of applying an Acetyl-CoA carboxylase (ACCase) inhibiting herbicide to the corn plants.

[2] The method according to [1], wherein the dicot crop is tolerant to PPO-inhibiting herbicides.

[3] The method according to [1] or [2], wherein the dicot crop is soybean or cotton.

[4] The method according to any one of [1] to [3], wherein the ACCase inhibiting herbicide is selected from the group consisting of clethodim, sethoxydim, tepraloxydim, fluazifop or its ester, fluiazifop-P or its ester, quizalofop or its ester, quizalofop-P or its ester, haloxyfop or its ester, and haloxyfop-P or its ester.

[5] The method according to any one of [1] to [4], wherein the ACCase inhibiting herbicide is applied with a PPO-inhibiting herbicide optionally with one or more different herbicides.

[6] The method according to [5], wherein a PPO-inhibiting herbicide selected from the group consisting of flumioxazin, trifludimoxazin, saflufenacil, fomesafen or its salt, lactofen, and ethyl [3-[2-chloro-4-fluoro-5-(1-methyl-6-trifluoromethyl-2,4-dioxo-1,2,3,4-tetrahydropyrimidine-3-yl)phenoxy]-2-pyridyloxy]acetate is fapplied.

Volunteer corn plants tolerant to PPO inhibiting herbicides in a cultivation area of dicot crops can be controlled by performing the method of the present invention. Also, volunteer corn plants in a cultivation area of dicot crops that are also tolerant to the PPO inhibitors can be controlled by performing the method of present invention, wherein the corn plants and the dicot crops are the transgenic ones each having specific gene sequences.

### DESCRIPTION OF EMBODIMENTS

The method of the present invention comprises a step of applying an Acetyl-CoA carboxylase (ACCase) inhibiting herbicide to volunteer corn plants in a cultivation area of dicot crops.

ACCase inhibiting herbicides (hereinafter referred as compounds of the present invention) are known compounds and are preferably selected from the group consisting of clethodim, sethoxydim, tepraloxydim, fluazifop or its ester, fluiazifop-P or its ester, quizalofop or its ester, quizalofop-P or its ester, haloxyfop or its ester, and haloxyfop-P or its ester. Preferable example of the esters are fluazifop-butyl, fuazifop-P-butyl, quizalofop-ethyl, quizalofop-P-ethyl, haloxyfop-methyl, and haloxyfop-P-methyl. Further preferable compounds of the present invention are clethodim and fluazifop-P-butyl. The most preferred compound of the present invention is clethodim.

In the present invention, the dicot crops are not limited as long as the dicot crops are a variety which can usually be cultivated as crops. The dicot crops are typically cotton, soybean, rape seed, sugar beet and sunflower, and preferably cotton and soybean, and most preferably soybean. Also in the present invention, the volunteer corn plants occurring in the cultivation of the dicot crops usually originate from unharvested seeds of the previous cropping of corn crop.

The aforementioned corn crops that are the source of the volunteer corn plants of the present invention are tolerant to PPO inhibitors, therefore the volunteer corn plants are also tolerant to PPO inhibitors. The PPO inhibitor tolerant corn crops include those provided with PPO reduced in compatibility with the inhibitors by genetic recombination technologies. Or, an ability which can detoxify or decompose these PPO inhibitors by the aid of cytochrome P450 monooxygenase may be contained either independently or in combination with the above PPO. These tolerant corn crops are described in patent documents such as WO2011085221, WO2012080975, WO2014030090, WO2015022640, WO2015022636, WO2015022639, WO2015092706, WO2016203377, WO2017198859, WO2018019860, WO2018022777, WO2017112589, WO2017087672, WO2017039969, WO2017023778, WO2018114759, WO2019118726, and non-patent documents (Pest Management Science, 61, 2005, 277-285).

The aforementioned dicot crops are optionally tolerant to PPO inhibitors by the aforementioned PPO or P450 monooxygenase.

The aforementioned dicot crops as well as the corn crops that are the source of the volunteer corn plants of the present invention may be the crops producible by natural crossing, crops producible by a mutation, F1 hybrid crops, or transgenic crops (also called genetically modified crops). These crops may have more characteristics such as impartment of tolerance to different herbicides, accumulation of substances harmful to pests, reduction in sensitivity to diseases, increase in yield potential, improvement in resistance to biological or non-biological stress factors, accumulation of substances, and improvement in preservability and processability.

The F1 hybrid crops are those which are each a first filial hybrid obtained by crossing two different varieties with each other and are usually those having characteristics superior in heterosis, that is a nature more excellent than both of the parents. The transgenic crops are those which are obtained by introducing an exogenous gene from other organisms such as microorganisms and have characteristics like those that cannot be easily obtained by crossbreeding, mutation induction, or natural recombination in natural environments.

Examples of the technologies used to create the above crops include conventional type variety improvement; genetic recombination technologies; genome breeding technologies; new breeding technologies; and genome editing technologies. The conventional type variety improvement is specifically a technology for obtaining crops having desired properties by a spontaneous mutation and crossing. The genetic recombination technologies are technologies in which a target gene (DNA) is extracted from a certain organism (for example, microorganism) to introduce it into a genome of a different target organism, thereby new properties to the organism, and antisense technologies or RNA interference technologies for imparting new or improved characteristics by silencing other genes existing in crops. The genome breeding technologies are those improving breeding efficiency by using genome information and include DNA marker (also called genome markers or genetical markers) breeding technologies and genomic selection. For example, the DNA marker breeding is a method in which a progeny having a gene with a target and useful trait is selected from a lot of cross progenies by using a DNA marker which is a DNA sequence and is a target of the presence position of a gene with a specific useful trait on a genome. This method has the characteristics that the time required for breeding can be efficiently reduced by analyzing the cross progeny by using a DNA marker when the progeny is a juvenile plant.

Also, the genomic selection is a technique in which a prediction formula is created from a phenotype obtained in advance and genome information, to predict the characteristics from the prediction formula and the genome information without any evaluation of the phenotype, and is a technology contributing to improvement in efficient breeding. The new breeding techniques are a generic term of variety improvement (=breeding) techniques that are combinations of molecular biological techniques. Examples of the new breeding techniques include cisgenesis/intragenesis, introduction of an oligonucleotide-directed mutation, RNA-dependent DNA methylation, genome editing, grafting onto a GM rootstock or scion, reverse breeding, agroinfiltration, and seed production technology (SPT). The genome editing technologies are those in which gene information is transformed in a sequence-specific manner which enables, for example, deletion of a base sequence, substitution of an amino sequence, and introduction of an exogenous gene. Examples of tools for these techniques include sequence-specific genome modification techniques such as zinc-finger nuclease (ZFN), TALEN, CRISPR/Cas9, CRISPER/Cpfl, and Meganuclease which each enable sequence-specific DNA scission and CAS9 Nickase and Target-AID which are each created by modifying the aforementioned tools.

Examples of the crops mentioned above include crops listed in GM APPROVAL DATABASE of genetically modified crops in the electronic information site (http://www.isaaa.org/) of INTERNATIONAL SERVICE for the ACQUISITION of AGRI-BIOTECH APPLICATIONS (ISAAA). More specifically, these examples include herbicide tolerant crops, harmful insect tolerant crops, disease tolerant crops, and quality modified (for example, increase or decrease in content or change in composition) crops of products (for example, starch, amino acid, and fatty acid), fertile trait modified crops, abiotic stress tolerant crops, or crops modified in traits relating to growth and yield.

Examples of crops having tolerance to different herbicides are given as follows.

The mechanism of tolerance to herbicides is obtained, for example, by reducing the compatibility of a chemical with its target, by rapid metabolism (for example, breakdown or modification) resulting from the expression of a chemical deactivation enzyme, or by inhibiting the incorporation of a chemical into a plant body or the transfer of the chemical in the plant body.

The crops to which herbicide tolerance is imparted by genetic recombination technologies include crops to which tolerances to the following inhibitors are imparted by genetic recombination technologies: 4-hydroxyphenyl pyruvate dioxygenase (hereinafter abbreviated as HPPD) inhibitors such as isoxaflutole and mesotrione, acetolactate synthetase (hereinafter: abbreviated as ALS) inhibitors such as imidazolinone type herbicides containing imazethapyr and sulfonylurea type herbicides containing thifensulfuron-methyl, 5-enolpyruvylshikimate-3-phosphate synthase (hereinafter abbreviated as EPSP) inhibitors such as glyphosate, glutamine synthetase inhibitors such as glufosinate, auxin type herbicides such as 2,4-D and dicamba, and oxynil type herbicides containing bromoxynil.

Examples of the herbicide tolerant crops are shown below:

Glyphosate herbicide tolerant crops: which are obtained by introducing one or more of a glyphosate tolerant EPSPS gene (CP4 epsps) derived from Agrobacterium tumefaciens strain CP4, glyphosate metabolism enzyme gene (gat4601, gat4621) obtained by strengthening the metabolism activity of a glyphosate metabolism enzyme (glyphosate N-acetyltransferase) gene derived from Bacillus licheniformis by shuffling technologies, glyphosate metabolism enzyme (glyphosate oxidase) gene (goxv247) derived from Ochrobacterum anthropi strain (LBAA), or EPSPS gene (mepsps, 2mepsps) having a glyphosate tolerance mutation derived from corn. Examples of main crops include rapeseed (Brassica napus), cotton (Gossypium hirsutum L.), corn (Zea mays L.), soybean (Glycine max L.), and sugar beet (Beta vulgaris). Some of these glyphosate tolerant transgenic crops are commercially available. For example, genetically modified crops expressing glyphosate tolerant EPSPS genes derived from Agrobacterium strains are commercially available under the names including “Roundup Ready (registered trademark)”, genetically modified crops expressing a glyphosate metabolism enzyme which is derived from Bacillus subtilis and obtained by strengthening its metabolism activity by shuffling technologies are commercially available under the names of “Optimum (registered trademark) GAT (trademark)”, “Optimum (registered trademark) Gly canola”, and the like. Genetically modified crops expressing the EPSPS genes having a glyphosate tolerance mutation derived from corn are commercially available under the name of “GlyTol (trademark)”. Glufosinate herbicide tolerant crops: which are obtained by introducing one or more of a phosphinothricin N-acetyltransferase (PAT) gene (bar) which is a glufosinate metabolism enzyme derived from Streptomyces hygroscopicus, phosphinothricin N-acetyltransferase (PAT) enzyme gene (pat) which is a glufosinate metabolism enzyme derived from Streptomyes viridochromogenes, and a synthesized pat gene (pat syn) derived from Streptomyes viridochromogenes strain Tu494. Examples of main crops include rapeseed (Brassica napus), cotton (Gossypium hirsutum L.), corn (Zea mays L.), soybean (Glycine max L.), and sugar beet (Beta vulgaris). Some of these glufosinate tolerant transgenic crops are commercially available. For example, genetically modified crops derived from a glufosinate metabolism enzyme (bar) derived from Streptomyces hygroscopicus and genetically modified crops derived from Streptomyes viridochromogenes are commercially available under the names including “LibertyLink (trademark)”, “InVigor (trademark)”, and “WideStrike (trademark)”. Oxynil type herbicides (for example, bromoxynil” tolerant crops: there are oxynil type herbicides, for example, bromoxynil tolerant transgenic crops, which are obtained by introducing a nitrilase gene (bxn) which is an oxynil type herbicide (for example, bromoxynil) metabolism enzyme derived from Klebsiella pneumoniae subsp. Ozaenae). Examples of main crops include rapeseed (Brassica napus) and cotton (Gossypium hirsutum L.). These crops are commercially available under the names including “Navigator (trademark) canola” and “BXN (trademark)”. There are also the following crops commercially available under the following names: ALS herbicide tolerant crops: Corn (Zea mays L.) “Optimum (trademark) GAT (trademark)” which is obtained by introducing an ALS herbicide tolerant ALS gene (zm-hra) derived from corn and is tolerant to sulfonylurea-type and imidazolinone-type herbicides; Soybean “Cultivance” which is obtained by introducing an ALS herbicide tolerant ALS gene (csr1-2) derived from thale cress and is tolerant to imidazolinone type herbicides; and Soybean “Treus (trademark)”, “Plenish (trademark)”, and “Optimum GAT (trademark)”, which is obtained by introducing an ALS herbicide tolerant ALS gene (gm-hra) derived from soybean (Glycine max) and is tolerant to sulfonylurea type herbicides. Also, cotton is available into which an ALS herbicide tolerant ALS gene derived from tobacco (Nicotiana tabacum cv. Xanthi) is introduced. HPPD herbicide tolerant crops: soybean into which mesotrione tolerant HPPD genes (avhppd-03) derived from oats (Avena sativa) and phosphinothricin N-acetyltransferase (PAT) enzyme genes (pat) tolerant to mesotrione which is a glufosinate metabolism enzyme derived from Streptomyes viridochromogenes are both introduced is commercially available under the name of “Herbicide-tolerant Soybean line (trademark)”. 2,4-D tolerant crops: corn obtained by introducing aryloxyalkanoate dioxygenase genes (aad-1) which are a 2,4-D metabolism enzyme derived from Sphingobium herbicidovorans is commercially available under the name of “Enlist (trademark) maize”. There are soybean and cotton obtained by introducing an allyloxyalkanoate dioxygenase gene (aad-12) which is a 2,4-D metabolism enzyme derived from Delftia acidovorans and these crops are commercially available under the name of “Enlist (trademark) Soybean”.

Dicamba tolerant crops: there are soybean and cotton obtained by introducing a Dicamba monooxygenase gene (dmo) which is a dicamba metabolism enzyme derived from Stenotrophomonas maltophilia strain DI-6. Soybean (Glycine max L.) obtained by introducing, in addition to the above gene, a glyphosate tolerant type EPSPS gene (CP4 epsps) derived from Agrobacterium tumefaciens strain CP4 is commercially available under the name of “Genuity (registered trademark) Roundup Ready (trademark) 2 Xtend (trademark)”.

Examples of commercially available products of the transgenic crops to which herbicide tolerance is imparted include glyphosate tolerant corn: “Roundup Ready Corn”, “Roundup Ready 2”, “Agrisure GT”, “Agrisure GT/CB/LL”, “Agrisure GT/RW”, “Agrisure 3000GT”, YieldGard VT Rootworm/RR2”, and “YieldGard VT Triple”; glyphosate resistant soybean: “Roundup Ready Soybean” and “Optimum GAT”; glyphosate tolerant cotton: “Roundup Ready Cotton” and “Roundup Ready Flex”; glyphosate tolerant rapeseed: “Roundup Ready Canola”; glufosinate tolerant corn: “Roundup Ready 2”, “Liberty Link”, “Herculex 1”, “Herculex RW”, “Herculex Xtra”, “Agrisure GT/CB/LL”, “Agrisure CB/LL/RW”, and “Bt10”; glufosinate tolerant cotton: “FiberMax Liberty Link”; glufosinate tolerant rapeseed: “in Vigor”; bromoxynil tolerant cotton: “BXN”; bromoxynil tolerant rapeseed: “Navigator” and “Compass”. Further crops modified in respect to herbicides are widely known. Examples of these crops include glyphosate tolerant crops such as rapeseed, sugar beet, and sunflower (see, for example, U.S. Pat. Nos. 5,188,642, 4,940,835, 5,633,435, 5,804,425, and 5,627,061); dicamba tolerant crops such as cotton, soybean, pea, sunflower, and corn (see, for example, WO2008051633, U.S. Pat. Nos. 7,105,724, and 5,670,454); glufosinate tolerant crops such as soybean and sugar beet (see, for example, U.S. Pat. Nos. 6,376,754, 5,646,024, and 5,561,236); 2,4-D tolerant crops such as cotton, sunflower, corn, and soybean (see, for example, U.S. Pat. Nos. 6,153,401, 6,100,446, WO2005107437, U.S. Pat. Nos. 5,608,147, and 5,670,454); crops tolerant to acetolactate synthase (ALS) inhibitors (for example, sulfonylurea type herbicides and imidazolinone type herbicides) such as rapeseed, corn, cotton, rapeseed, soybean, and sunflower (see, for example, U.S. Pat. No. 5,013,659, WO2006060634, U.S. Pat. Nos. 4,761,373, 5,304,732, 6,211,438, 6,211,439, and 6,222,100); and crops resistant to HPPD inhibitors (for example, isoxazole type herbicides such as isoxaflutole, triketone type herbicides such as sulcotrione and mesotrione, pyrazole type herbicides such as pyrazolynate, and diketonitrile which is a degradation product of isoxaflutole), such as corn, soybean, cotton, rape seed, and sugar beet (see, for example, WO2004/055191, WO199638567, WO1997049816 and U.S. Pat. No. 6,791,014).

Examples of crops to which herbicide tolerance is imparted classically or by genome breeding technologies include sunflower “Clearfield Sunflower” and rape seed “Clearfield canola” (BASF products), which are each tolerant to imidazolinone type ALS inhibitors such as imazethapyr and imazamox; soybean “STS soybean” tolerant to sulfonyl type ALS inhibitors such as thifensulfuron-methyl; sethoxydim tolerant corn “SR corn” and “Poast Protected (registered trademark) corn” having tolerance to acetyl CoA carboxylase inhibitors such as trione-oxime type or aryloxyphenoxypropionate type herbicides; sunflower “ExpressSun (registered trademark)” having tolerance to sulfonylurea type herbicides such as tribenuron-methyl; and rapeseed “Triazinon Tolerant Canola” having tolerance to a PSII inhibitor.

Examples of crops to which herbicide tolerance is imparted by genome editing technologies include rape seed “Su Canola (registered trademark)” having tolerance to sulfonylurea type herbicides and which are developed using Rapid Trait Development System (RTDS) (registered trademark). This RTDS (registered trademark) is a technology corresponding to the introduction of an oligonucleotide-directed mutation in genome editing technologies and is a technology enabling the introduction of a mutation through Gene Repair Oligonucleotide (GRON), that is, DNA-RNA chimeric oligonucleotide without cutting of DNA in the plant. Also, herbicide tolerant corn reduced in phytic acid content by using zinc finger nuclease to delete an endogenous gene IPK1 (see, for example, Nature 459, 437-441, 2009).

With regard to the crops to which herbicide tolerance is imparted, examples in which the nature of a rootstock is transferred to a scion in breeding technologies utilizing grafting include an example in which glyphosate tolerance is imparted to a scion of non-transgenetic soybean by using Roundup Ready (registered trademark) soybean having glyphosate tolerance as the rootstock (see, Weed Technology 27:412-416, 2013).

The corn crops and the dicot crops of the present invention may be imparted with further traits that are different from herbicide tolerance, such as insect resistance, disease resistance, abiotic stress tolerance, enhanced nutrient contents and utilization, fertility/sterility modification, harvest quality improvements, and growth/yield improvements, and so on.

Examples of crops to which pest resistance is imparted are shown below.

Examples of crops to which resistance to lepidopterous pests is imparted by genetic recombination technologies include crops such as corn (Zea mays L.), soybean (Glycine max L.), and cotton (Gossypium hirsutum L.) each obtained by introducing a gene encoding δ-endotoxin which is an insecticidal protein derived from Bacillus thuringiensis (hereinafter abbreviated as Bt bacteria) which is soil bacteria. Examples of the δ-endotoxin imparting resistance to lepidopterous pests include Cry1A, Cry1Ab, modified Cry1Ab (partially deficient Cry1Ab), Cry1Ac, Cry1Ab-Ac (hybrid protein of combined Cry1Ab and Cry1Ac), Cry1C, Cry1F, Cry1Fa2 (modified cry1F), moCry1F (modified Cry1F), Cry1A.105 (hybrid protein of combined Cry1Ab, Cry1Ac, and Cry1F), Cry2Ab2, Cry2Ae, Cry9C, Vip3A, and Vip3Aa20. Examples of crops to which resistance to coleopterous pests is imparted by genetic recombination technologies include crops such as corn, each obtained by introducing a gene encoding δ-endotoxin which is an insecticidal protein derived from Bt bacteria which are soil bacteria. Examples of the δ-endotoxin imparting resistance to coleopterous pests include Cry3A, mCry3A (modified Cry3A), Cry3Bb1, Cry34Ab1, and Cry35Ab1. Examples of crops to which resistance to dipterous pests is imparted by genetic recombination technologies include crops such as genetically modified corn (Zea mays L.) obtained by introducing a synthesized gene encoding a hybrid protein eCry3.1Ab of a combination of Cry3A and Cry1Ab derived from Bt bacteria which are soil bacteria, and genetically modified cotton (Gossypium hirsutum L.) obtained by introducing a gene encoding a trypsin inhibitor CpTI derived from cowpea (Vigna unguiculate). Further examples include genetically modified poplar obtained by introducing a gene encoding API which is a protease inhibitor protein A derived from arrowhead (Sagittaria sagittifolia). These crops have tolerance to a wide range of pests.

The insecticidal proteins imparting pest resistance to crops include hybrid proteins of the above insecticidal proteins, partially deficient proteins, and modified proteins. The hybrid proteins are produced by a combination of different domains of a plurality of insecticidal proteins and for example, Cry1Ab-Ac and Cry1A.105 are known. As the partially deficient proteins, Cry1Ab deficient in a part of amino acid sequences is known. As the modified proteins, Cry1Fa2, moCry1F, mCry3A, and the like are known that are proteins in which one or plural amino acids of natural type δ-endotoxin are substituted. Also, in the amino acid substitution like this, a protease recognition sequence which does not exist in nature is preferably inserted into toxin as shown in the case (see WO2003/018810) of Cry3A055.

Monsanto Company has developed cotton (evento MON88702) obtained by introducing a modified BT protein Cry51Aa2 (Cry51Aa2.834 16) by genetic recombination technologies and the cotton has resistance to genus Lygus such as Lygus lineolaris, Hemiptera such as aphid and Thysanoptera such as genus Frankliniella. Other than the above, examples of the insecticidal protein imparting pest resistance to crops by genetic recombination technologies include insecticidal proteins derived from Bacillus cereus or Bacillus popilliae, vegetable proteins Vip1, Vip2, Vip3, and Vip3A derived from Bt bacterium strain AB88, insecticidal proteins derived from nematode symbiotic (forms a colony in nematode) bacteria, for example, Photorhabdus spp. such as Photorhabdus luminescens and Xenorhabdus nematophilus and Xenorhabdus spp. such as Xenorhabdus nematophilus, toxins produced from animals having neurotoxins specific to insects, such as a scorpion toxin, spider toxin, and bee toxin, toxins of filamentous fungi such as a Streptomycetes toxin, vegetable lectin such as pea lectin, barley lectin, and snowdrop lectin, protease inhibitors such as agglutinin, trypsin inhibitor, serine protease inhibitor, protease inhibitors such as patatin, cystatin, and papain inhibitor, ribosome inactivation proteins (RIP) such as lysine, corn-RIP, abrin, luffin, saporin, and bryodin, steroid metabolism enzymes such as 3-hydroxysteroidoxydase, ecdysteroid-UDP-glucosyltransferase, and cholesterol oxidase, ion channel inhibitors such as an ecdysone inhibitor, HMG-CoA-reductase, and sodium channel or calcium channel inhibitor, juvenile hormone esterase, diuretic hormone receptor, stilbene synthase, bibenzyl synthase, chitinase, and glucanase.

Crops to which pest resistance is imparted by introducing one or two or more insecticidal protein genes have been already known and some of these crops are commercially available. Examples of cotton having pest resistance include “Bollgard (trademark) cotton”, “BXN (trademark) Plus Bollgard (trademark) Cotton”, “BXN (trademark) Plus Bollgard (trademark) Cotton”, “JK 1”, “Roundup Ready (trademark) Bollgard (trademark) Cotton”, and “Ingard (trademark)”, which each express an insecticidal protein Cry1Ac derived from Bt bacteria, “Herculex(trademark) I” and “Herculex(trademark) CB”, which each express an insecticidal protein modified Cry1F (Cry1Fa2) derived from Bt bacteria; “VIPCOT (trademark) Cotton” expressing an insecticidal protein Vip3A derived from Bt bacteria; “Bollgard II (trademark) cotton”, “Roundup Ready(trademark) Bollgard II (trademark) Cotton”, “Roundup Ready (trademark) Flex (trademark) Bollgard II (trademark) Cotton” and “Fivermax (trademark) Liberty Link (trademark) Bollgard II (trademark)”, which each express insecticidal proteins Cry1Ac and Cry2Ab derived from Bt bacteria; “Bollgard III (registered trademark) cotton” and “Bollgard (registered trademark) III×Roundup Ready (trademark) Flex (trademark)”, which express insecticidal proteins Cry1Ac, Cry2Ab, and Vip3A derived from Bt bacteria, “VIPCOT (trademark) Roundup Ready Flex (trademark) Cotton” expressing insecticidal proteins Vip3A and Cry1Ab derived from Bt bacteria; “VIPCOT (registered trademark)” expressing insecticidal proteins Vip3A and Cry1Ac derived from Bt bacteria; “WideStrike (trademark) Cotton”, “WideStrike (trademark) Roundup Ready (trademark) Cotton”, and “Widestrike (trademark) Roundup Ready Flex (trademark) Cotton”, which express insecticidal proteins Cry1Ac and Cry1F derived from Bt bacteria; “VIPCOT (trademark) Cotton expressing an insecticidal protein Vip3A derived from Bt bacteria; “TwinLink (trademark) Cotton” and “Glytol (trademark)×Twinlink (trademark), which express insecticidal proteins Cry1Ab and Cry2Ae derived from Bt bacteria; “Widestrike (registered trademark) 3” and “Widestrike (trademark)×Roundup Ready Flex (trademark)×VIPCOT (trademark) Cotton”, which express insecticidal proteins Cry1Ac, Cry1F, and Vip3A derived from Bt bacteria; and “Glytol (trademark)×Twinlink (trademark)×VIPCOT (trademark) Cotton” expressing insecticidal proteins Cry1Ab, Cry2Ae, and Vip3A derived from Bt bacteria.

Examples of the corn having pest resistance include “YieldGard (registered trademark) Rootworm RW”, “YieldGard (trademark) RW+RR”, “YieldGard (trademark) VT (trademark) Rootworm (trademark) RR2”, and “MaxGard (trademark)”, which express an insecticidal protein Cry3Bb1 derived from Bt bacteria; “YieldGard (registered trademark) VT Triple” and “YieldGard (trademark) Plus with RR”, which express insecticidal proteins Cry3Bb1 and Cry1Ab derived from Bt bacteria; “Bt Xtra (trademark) Maize” expressing an insecticidal protein Cry1Ac derived from Bt bacteria; “YieldGard Plus (registered trademark)” expressing insecticidal proteins Cry1Ab and Cry3Bb1 derived from Bt bacteria; “Bt10”, “Liberty Link(trademark) Yieldgard (trademark) Maize”, “Agrisure (trademark) GT/CB/LL”, and “YieldGard (trademark) CB+RR” expressing an insecticidal protein Cry1Ab derived from Bt bacteria; “YieldGard (trademark) VT Pro (trademark)” and “Genuity (registered trademark) VT Double Pro (trademark)”, which express insecticidal proteins Cry1A. 105 and Cry2Ab2 derived from Bt bacteria; “Agrisure (registered trademark) RW” and “Agrisure (trademark) GT/RW”, which express an insecticidal protein mCry3A derived from Bt bacteria; “Starlink (trademark) Maize” expressing an insecticidal protein Cry9C derived from Bt bacteria; “YieldGard (trademark)”, “MaizeGard (trademark)”, “NaturGard KnockOut (trademark)”, “Maximizer (trademark)”, “Roundup Ready (trademark) YieldGard (trademark) Maize”, “Agrisure (trademark) CB/LL”, and “Mavera (trademark) YieldGard (trademark) Maize”, which express an insecticidal protein Cry1Ab derived from Bt bacteria; “Agrisure (registered trademark) 3122” expressing insecticidal proteins Cry1Ab, Cry1F, modified Cry3A, Cyr34Ab1, and Cyr35Ab1 derived from Bt bacteria; “Agrisure (registered trademark) Viptera” expressing an insecticidal protein Vip3Aa20 derived from Bt bacteria; “Agrisure (registered trademark) Viptera (trademark) 2100” and “Agrisure (registered trademark) Viptera (trademark) 3110”, which express insecticidal proteins Vip3Aa20 and Cry1Ab derived from Bt bacterial; “Agrisure (registered trademark) Viptera (trademark) 3100”, “Agrisure(registered trademark) Viptera (trademark) 3111” and “Agrisure (registered trademark) Viptera (trademark) 4”, which express insecticidal proteins Vip3Aa20, Cry1Ab, and modified Cry3A derived from Bt bacteria; “Agrisure (registered trademark) Viptera (trademark) 3220” expressing insecticidal proteins Vip3Aa20, Cry1Ab, and modified Cry1F derived from Bt bacteria; “Agrisure (registered trademark” Duracade (trademark)” expressing an insecticidal protein eCry3.1Ab (Cry3A-Cry1Ab chimera protein) derived from Bt bacteria; “Agrisure (registered trademark) Duracade (trademark) 5122” expressing insecticidal proteins eCry3.1Ab (Cry3A-Cry1Ab chimera protein), modified Cry3A, Cry1Ab, and modified Cry1F derived from Bt bacteria; “Agrisure (registered trademark) Duracade (trademark) 5222” expressing insecticidal proteins eCry3.1Ab (Cry3A-Cry1Ab chimera protein), modified Cry3A, modified Cry1Ab, and Vip3A variant derived from Bt bacteria; “Herculex (trademark) RW” expressing insecticidal proteins Cyr34Ab1 and Cyr35Ab1 derived from Bt bacteria; “Herculex XTRA (trademark)” expressing insecticidal proteins Cyr34Ab1, Cyr35Ab1, and Cry1F derived from Bt bacteria; “Genuity (registered trademark) VT Triple Pro (trademark)” expressing insecticidal proteins Cry1A. 105, Cry2Ab2, and Cry3Bb1 derived from Bt bacteria; “Genuity (registered trademark) SmartStax (trademark)” expressing insecticidal proteins Cry1F, Cry2Ab, Cyr34Ab1, Cyr35Ab1, Cry3Bb1, and Cry1A. 105 derived from Bt bacteria; “Power Core (trademark)” expressing insecticidal proteins, modified Cry1F, Cry2Ab, and Cry1A. 105 derived from Bt bacteria; “Herculex XTRA (trademark) RR” expressing insecticidal proteins Cry1F, Cyr34Ab1, and Cyr35Ab1 derived from Bt bacteria; “Optimum (registered trademark) Intrasect Xtreme” expressing insecticidal proteins, modified Cry1F, Cyr34Ab1, Cyr35Ab1, Cry1Ab, and modified Cry3A derived from Bt bacteria; “Optimum (registered trademark) Intrasect XTRA” expressing insecticidal proteins, modified Cry1F, Cyr34Ab1, Cyr35Ab1, and Cry1Ab derived from Bt bacteria; and “Optimum (registered trademark) TRIsect” expressing insecticidal proteins, modified Cry1F and modified Cyr3A derived from Bt bacteria: these products being all commercially available.

Examples of other crops having pest resistance include soybean “Intacta (trademark) Roundup Ready (trademark) 2 Pro” expressing an insecticidal protein Cry1Ac derived from Bt bacteria, these products being each commercially available. Specifically, the following crop products are available: corn “YieldGard corn rootworm” and “YieldGard VT”, “Herculex RW” and “Herculex Rootworm”, and “Agrisure CRW”, which have resistance to corn rootworms; corn “YieldGard corn borer”, “YieldGard plus” and “YieldGard VT Pro”, “Agrisure CB/LL” and “Agrisure 3000GT”, “Hercules I”, and “Hercules II”, “KnockOut”, “NatureGard”, and “StarLink”, which have resistance to corn borers; corn “Herculex I” and “Herculex Xtra”, “NewLeaf”, “NewLeaf Y”, and “NewLeaf Plus”, which have resistance to western bean cutworms, corn borers, black cutworms, and fall armyworms; corn “YieldGard Plus” having resistance to corn borers and corn rootworms; cotton “Bollgard I” and “Bollgard II”, which have resistance to Heliothis virescens; and cotton “Bollgard II”, “WideStrike”, and “VipCot”, which have resistance to Heliothis virescens, cotton bollworms, fall armyworms, beet armyworms, cabbage loopers, soybean loopers, and pink bollworms.

As crops to which insect pest resistance is imparted by RNA interference technologies, corn resistant to Lepidoptera insect pests (for example, corn borers, cutworms such as corn earworms and black cutworms, and fall armyworms) and Coleoptera insect pests (corn rootworms) is commercially available or is developed under the names of “SmartStax (registered trademark)”, “SmartStax (registered trademark) Pro”, “Genuity (registered trademark) SmartStax”.

Examples of crops to which pest resistance is imparted classically or by genome breeding technologies include aphid resistant soybean having a Rag1 (Resistance Aphid Gene 1) gene; soybean having resistance to Cysto nematode; cotton having resistance to Root Knot nematode; and soybean “FUKUNOMINORI” having resistance to Spodoptera litura.

Resistance to optional insect pests (especially Lepidoptera insects, Coleoptera insects, and Diptera insects), noxious arachnids, and noxious nematodes are imparted to crops to which resistance to these insect pests is imparted. Crops to which pest resistance is imparted are preferably selected from corn, rape seed, soybean, sugar beet, and sunflower, more preferably selected from soybean, corn, and cotton.

Examples of the crops to which disease tolerance is imparted are given below.

Crops to which disease tolerance is imparted by genetic recombination technologies are those expressing so-called “pathogen related proteins” (PRP, see, for example, EP0392225) or so-called “antifungal proteins” (AFP, see, for example, U.S. Pat. No. 6,864,068). Various antifungal proteins having activity to plant pathogenic fungi are isolated from specific crops and become commonly used. Examples of such pathogenic substances and crops enabling synthesis of these plant pathogenic substances are well known from EP0392225, WO1993/05153, WO1995/33818, and EP0353191. Crops resistant to fungicidal pathogens, viral pathogens, and bacterial pathogens are produced by introducing plant resistant genes.

Examples of crops in which contents in these crops are modified are given below.

The modification of contents in a plant implies increase and decrease in synthesis of modified compounds or synthetic amount of chemical substances as compared with the corresponding wild-type crops. There are, for example, modified crops increased or decreased in the contents of vitamins, amino acids, proteins, and starch, and various oils and modified crops reduced in nicotine content.

Examples of crops modified in content by genetic recombination technologies include rape seed “Laurical (trademark) Canola” increased in the content of triacylglyceride containing lauric acid by introducing 12:0 ACP thioesterase derived from laurier (Umbellularia californica) relating to fatty acid synthesis; soybean “Plenish (trademark)” or “Treus (trademark)” increased in oleic acid content through reduction of gene expression by introducing a partial gene sequence (gm-fad2-1) of ω-6 desaturase which is an unsaturated enzyme of fatty acid and is derived from soybean; Soybean “Vistive Gold (trademark)” reduced in fatty acid content by introducing a gene creating a double strand DNA of an acyl-acyl carrier-protein-thioesterase gene (fatb1-A) derived from soybean and a gene creating a double strand DNA of a δ-12 desaturase gene (fad2-1A) derived from soybean; genetically modified soybean increased in the content of ω3 fatty acid by introducing a δ-6 desaturase gene (Pj.D6D) derived from primrose and δ-12 desaturase gene (Nc. Fad3) derived from red bread mold; corn “Enogen (registered trademark)” increased in productivity of bioethanol by introducing a heat resistant α-amylase gene (amy797E) of Thermococcales sp. relating to amylolysis; corn “Mavera (trademark) Maize” and “Mavera (trademark) YieldGard (trademark) Maize” increased in productivity of lysin by introducing a dihydrodipicolinate synthetase gene (cordapA) derived from Corynebacterium glutamicum relating to the production of lysin that is an amino acid.

As crops modified in content either classically or by genome breeding technologies, rape seed “Nexera (registered trademark) Canola” producing unsaturated ω-9 fatty acid; and soybean “Yumeminori” reduced in allergen content.

Crops modified in plant nutrient utilization are those improved in assimilation or metabolization of nitrogen or phosphorus. Crops having nitrogen assimilation ability and nitrogen utilization ability enhanced by genetic recombination technologies are selected from rape seed, corn, sunflower, soybean, cotton, and sugar beet (see, for example, WO1995009911, WO1997030163, U.S. Pat. Nos. 6,084,153, 5,955,651, and 6,864,405). Crops improved in phosphorous uptake by genetic recombination technologies include rape seed, corn, cotton, soybean, sugar beet, and sunflower (see, for example, U.S. Pat. No. 7,417,181 and US 20050137386). The methods of manufacturing such crops are generally known to a person skilled in the art and these crops are, for example, disclosed in the above publications.f

As crops modified in fertility trait and the like by genetic recombination technologies, crops to which male sterility and fertility restoring traits are imparted are exemplified. Examples of these crops include corn to which a male sterility trait is imparted by expressing a ribonuclease gene (barnase) derived from Bacillus amyloliquefaciens in tapetum cells of an anther; corn to which male sterility trait is imparted by introducing a DNA adeninemethylase gene (dam) derived from Escherichia coli; corn controlled in fertility trait by introducing an α-amylase gene (zm-aa1) derived from corn imparting a male sterility trait and a ms45 protein gene (ms45) derived from corn imparting a fertility restoring trait; rape seed to which fertility restoring ability is imparted by expressing a ribonuclease inhibitory protein gene (barstar) derived from Bacillus in tapetum cells of an anther; and rape seed controlled in a fertility trait by expressing a ribonuclease gene (barnase) derived from Bacillus imparting a male sterility trait and a ribonuclease inhibitory protein gene (barstar) derived from Bacillus imparting a fertility restoring trait. Other examples of crops to which a fertility trait is imparted by genetic recombination technologies include soybean and sunflower (see, for example, U.S. Pat. Nos. 6,720,481, 6,281,348, 5,659,124, 6,399,856, 7,345,222, 7,230,168, 6,072,102, EP1135982, WO2001092544, and WO1996040949). The methods of manufacturing such crops are generally known to a person skilled in the art and these crops are, for example, disclosed in the above publications. These crops are preferably selected from corn, rape seed, and soybean.

Crops to which non-biological stress tolerance is imparted are those increased in tolerance to nonbiological stress condition such as drought, high salt content, high light intensity, high UV irradiation, chemical contamination (for example, high concentrations of heavy metals), low or high temperature, limited supply of nutrients, and collective stress (see, for example, WO200004173, WO2007131699, CA2521729, and US20080229448).

Examples of crops to which non-biological stress tolerance is imparted include corn, soybean, rape seed, and cotton, which have tolerance to drought (see, for example, WO2005048693, WO2008002480, and WO 2007030001); corn, soybean, cotton, and rape seed, which have tolerance to low temperature (see, for example, U.S. Pat. No. 4,731,499 and WO2007112122); and cotton, soybean, and sunflower, which have tolerance to high salt content (see, for example, U.S. Pat. Nos. 7,256,326, 7,034,139, and WO/2001/030990). Examples of these crops also include corn “DroughtGard (registered trademark)” (product from Monsanto) into which a cold shock protein gene cspB of Bacillus subtilis is introduced.

As the crops to which abiotic stress tolerance is imparted either classically or by genome breeding technologies, for example, corn having drought tolerance are commercially available under the names of “Agrisure Artesian (registered trademark) and “Optimum (registered trademark) AQUAmax (trademark)”.

Examples of crops modified in other qualities by genetic recombination technologies include rape seed “Phytaseed (registered trademark) Canola” improved in the degradation of endogenous phytic acid by introducing a 3-phytase gene (phyA) derived from Aspergillus niger that is an enzyme that breaks down plant phytic acid; and cotton producing high-quality fibers improved in fiber micronaire, fiber strength increase, length uniformity, and color (see, for example, WO 1996/26639, U.S. Pat. Nos. 7,329,802, 6,472,588, and WO 2001/17333).

Examples of crops modified in plant growth and yield include crops improved in growing ability. As crops modified by genetic recombination technologies, soybean has been developed which is improved in plant growth with the expectation of resultant high yield by introducing a gene (bbx32) encoding a transcription factor controlling daily periodicity specific to thale cress; and corn has been also developed which is increased in female panicle weight with the expectation of resultant high yield by introducing a transcription factor gene (athb17) belonging to homeodomain-leucine 14 zipper (HD-Zip) family, class II (HD-Zip II) derived from thale cress.

Examples of crops modified in quality by genome editing technologies include corn “ZFN-12 maize” reduced in phytic acid content by using zinc finger nuclease to delete an IPK1 gene encoding inositol-1,3,4,5,6-pentakisphosphate 2-kinase that is a phytic acid synthetic enzyme; and mushroom to which browning tolerance is imparted by using CRISPR-Cas9 to delete a gene encoding a polyphenol oxidase (see, for example, Nature., Vol 532, 21 APRIL, 2016).

The above crops include plant lines added with two or more of the properties like those mentioned above, for example, abiotic stress tolerance, disease tolerance, herbicide tolerance, pest tolerance, growth and yield traits, nutrient-uptake, product qualities, and sterility trait by using genetic recombination technologies, classical breeding technologies, genome breeding technologies, new breeding technologies, or genome editing technologies and plant lines added with two or more of natures specific to parent lines by crossing lines with a plant of the same kind, or with a plant having different natures.

Examples of commercially available crops to which tolerance to two or more herbicides is imparted include cotton “GlyTol (trademark) LibertyLink (trademark)” and “GlyTol (trademark) LibertyLink (trademark)” having tolerance to glyphosate and glufosinate; corn “Roundup Ready (trademark) LibertyLink (trademark) Maize” having tolerance to glyphosate and glufosinate; soybean “Enlist (trademark) Soybean” having tolerance to glufosinate and 2,4-D; soybean “Genuity (trademark) Roundup Ready (trademark) 2 Xtend (trademark)” having tolerance to glyphosate and dicamba; corn and soybean “OptimumGAT (trademark)” having tolerance to glyphosate and ALS inhibitors; genetically modified soybean “Enlist E3 (trademark)” and “Enlist (trademark) Roundup Ready 2 Yield (trademark) having tolerance to three herbicides: glyphosate, glufosinate, and 2,4-D; genetically modified corn “Enlist (trademark) Roundup Ready (registered trademark) Corn 2” having tolerance to glyphosate, 2,4-D, and allyloxyphenoxypropionate type (FOPs) herbicides; genetically modified corn “Enlist (trademark) Roundup Ready (registered trademark) Corn 2” having tolerance to glyphosate, 2,4-D, and allyloxyphenoxypropionate type (FOPs) herbicides; genetically modified cotton “Bollgard II (registered trademark) XtendFlex (trademark) Cotton” having tolerance to dicamba, glyphosate, and glufosinate; and genetically modified cotton “Enlist (trademark) Cotton” having tolerance to three herbicides: glyphosate, glufosinate, and 2,4-D. Other than the above, cotton having tolerance to glufosinate and 2,4-D, cotton having tolerance to both glufosinate and dicamba, corn having tolerance to both glyphosate and 2,4-D, soybean having tolerance to both glyphosate and HPPD herbicides, and genetically modified corn having tolerance to glyphosate, glufosinate, 2,4-D, allyloxyphenoxypropionate type (FOPs) herbicides, and cyclohexadione type (DIMs) herbicides are also developed.

Examples of commercially available products of crops to which herbicide tolerance and pest resistance are imparted include corn “YieldGard Roundup Ready” and “YieldGard Roundup Ready 2” having glyphosate tolerance and corn borer resistance; corn “Agrisure CB/LL” having glufosinate tolerance and corn borer resistance; corn “Yield Gard VT Root worm/RR2” having glyphosate tolerance and corn rootworm resistance; corn “Yield Gard VT Triple” having glyphosate tolerance and corn rootworm resistance and corn borer resistance; corn “Herculex I” having glufosinate tolerance and Lepidoptera insect pest resistance (Cry1F) (resistance to, for example, a western bean cutworm, corn borer, black cutworm, and fall armyworm); corn “YieldGard Corn Rootworm/Roundup Ready 2” having glyphosate tolerance and corn root worm resistance; corn “Agrisure GT/RW” having glufosinate tolerance and Coleoptera insect pest resistance (Cry3A) (resistance to, for example, a western corn rootworm, northern corn rootworm, and Mexican corn rootworm); corn “Herculex RW” having glufosinate tolerance and Coleoptera insect pest resistance (Cry34/35Ab1) (resistance to, for example, a western corn rootworm, northern corn rootworm, and Mexican corn rootworm); corn “Yield Gard VT Root worm/RR2” having glyphosate tolerance and corn rootworm resistance; and cotton “Bollgard 3 (registered trademark) XtendFlex (registered trademark)” having dicamba tolerance, glyphosate tolerance, glufosinate tolerance, and Lepidoptera insect pest resistance (resistance to, for example, bollworms, tobacco budworm, and armyworms).

Examples of commercially available crops to which herbicide tolerance and modified product quality are imparted include rape seed “InVigor (trademark) Canola” to which glufosinate tolerance and fertility trait are imparted; corn “InVigor (trademark) Maize” to which glufosinate tolerance and fertility trait are imparted; and soybean “Vistive Gold (trademark)” modified in glyphosate tolerance and oil content.

Examples of commercially available crops having three or more traits include corn “Herculex I/Roundup Ready 2” having glyphosate tolerance, glufosinate tolerance, and Lepidoptera insect pest resistance (Cry1F) (specifically, resistance to western bean cutworm, corn borer, black cutworm, and fall armyworm); corn “YieldGard Plus/Roundup Ready 2” having glyphosate tolerance, corn rootworm resistance, and corn borer resistance; corn “Agrisure GT/CB/LL” having glyphosate tolerance, glufosinate tolerance, and corn borer resistance; corn “Herculex Xtra” having glufosinate tolerance, Lepidoptera insect pest resistance (Cry1F), and Coleoptera insect pest resistance (Cry34/35Ab1) (specifically, resistance to Lepidoptera insect pests such as a western bean cutworm, corn borer, black cutworm, and fall armyworm and resistance to Coleoptera insect pests such as western corn rootworm, northern corn rootworm, and Mexican corn rootworm); corn “Agrisure CB/LL/RW” having glufosinate tolerance, corn borer resistance (Cry1Ab), and Coleoptera insect pest resistance (Cry3A) (specifically, resistance to Coleoptera insect pests such as western corn rootworm, northern corn rootworm, and Mexican corn rootworm); corn “Agrisure (trademark) 3000GT” having glyphosate tolerance+corn borer resistance (Cry1Ab), and Coleoptera insect pest resistance (Cry3A) (specifically, resistance to western corn rootworm, northern corn rootworm, and Mexican corn rootworm); corn “Mavera high-value corn” having glyphosate tolerance, resistance to a corn rootworm and European corn borer, and a high lysine trait; corn “Optimum (registered trademark) Leptra (trademark)” having resistance to pests such as a European corn borer, southwestern corn borer, corn earworm, fall armyworm, black cutworm, and western beanworm causing damages on the ground,

Soybean “Credenz (registered trademark) soybean” which is added with resistance to frogeye leaf spot, Sudden death syndrome, southern stem canker, Phytophthora root rot, southern root-knot nematode, Sclerotinia white mold, brown stem rot, and soybean cyst nematode, is improved in iron chlorosis, and is modified in chloride sensitivity, and cotton “Stoneville (registered trademark) Cotton” to which tolerance to a plurality of herbicides and pest resistance are imparted, while there are nine cotton varieties ST5517GLTP, ST4848GLT, ST4949GLT, ST5020GLT, ST5115GLT, ST6182GLT, ST4747GLB2, ST4946GLB2, and ST6448GLB2 to cope with the situation of the outbreak of weeds and noxious insects on the fields in various districts.

In the method of the present invention, the compound of the present invention is usually mixed with a carrier such as a solid or liquid carrier, to which a formulation auxiliary such as a surfactant is further added according to the need to make a formulation upon use. The formulation type is preferably an aqueous liquid suspension concentrate, oil suspension, wettable powder, water dispersible granule, granule, water-based emulsion, oil-based emulsion, and emulsifiable concentrate, more preferably emulsifiable concentrate. A formulation containing the compound of the present invention singly as an active ingredient may be independently used or may be used in combination with a formulation containing other herbicides as active ingredients. Also, a formulation containing the compound of the present invention and other herbicide as active ingredients may be used. Also, a formulation containing the compound of the present invention and other herbicides as active ingredients may be used in combination with a formulation containing, as active ingredients, herbicides different from the above herbicides.

Examples of the method of applying the compound of the present invention include a method in which each of these compounds is sprayed to volunteer corn plants after these corn emerges. The spraying is usually performed using a spray dilution produced by mixing a formulation containing the compound of the present invention with water and using a spraying machine equipped with a nozzles. The amount of the dilution to be sprayed is usually 50 to 1000 L/ha, preferably 100 to 500 L/ha, and more preferably 150 to 300 L/ha though no particular limitation is imposed on it.

The amount of the compound of the present invention to be applied is generally 1 to 1000 g, preferably 2 to 500 g, more preferably 5 to 200 g, and even more preferably 10 to 100 g per 10000 m² of the cultivation area. When applying the compound of the present invention, an adjuvant may be used together. Although no particular limitation is imposed on the kind of adjuvant, examples of the adjuvant include an oil type such as Agri-Dex and MSO, nonionic type such as Induce (ester or ether of polyoxyethylene), anionic type such as Gramin S (substituted sulfonate), and cationic type such as Genamin T 200BM (polyoxyethyleneamine), and organic silicone type such as Silwett L77. Moreover, a drift-reducing agent such as Intact (polyethylene glycol) may be added in the dilution.

The pH and hardness of the spraying dilution are usually in a range from 5 to 9 and in a range from 0 to 500 respectively though no particular limitation is imposed on the pH and hardness.

The time range of the application of the compound of the present invention is usually in a range from 5 a.m. to 9 p.m., though no particular limitation is imposed on the time range and the photon flux density at cultivation area when applying the compound of the present invention is usually 10 to 2500 μmol/m²/s.

The spray pressure when applying the compound of the present invention is usually 30 to 120 PSI and preferably 40 to 80 PSI though no particular limitation is imposed on it. Here, the spray pressure is a set value just before the dilution is introduced into the nozzle.

The nozzle used in the method of the present invention may be drift-reducing nozzles or standard nozzles. Examples of standard nozzles excluding drift-reducing nozzles include a Teejet110 series and XR Teejet110 series manufactured by Teejet Company. These nozzles are each operated under usual spray pressure (generally 30 to 120 PSI) and the volume median diameter of liquid droplets discharged from the nozzle is usually less than 430 μm. Examples of the drift-reducing nozzle to be used in the method of the present invention is a nozzle which is more reduced in drift as compared with a standard nozzle and which is called an air induction nozzle or pre-orifice nozzle. The volume median diameter of a liquid droplet discharged from the drift-reducing nozzle is usually 430 μm or more.

The air induction nozzle is a nozzle which is provided with an air introduction portion between the inlet (chemical dilution introduction portion) and outlet (chemical dilution discharge portion) of the nozzle to mix air with the chemical dilution thereby forming air-enriched liquid droplets. Examples of the air induction nozzle include TDXL11003-D, TDXL11004-D1, TDXL11005-D1, and TDXL11006-D manufactured by Green Leaf Technology Company, TTI110025, TTI11003, TTI11004, TTI11005, TTI110061, and TTI110081 manufactured by Teejet Company, and ULD120-041, ULD120-051, and ULD120-061 manufactured by Pentair Company. TTI11004 is particularly desirable.

The pre-orifice nozzle is a nozzle in which its import (chemical dilution introduction portion) serves as a metering orifice which limits the amount of the fluid entering the inside of the nozzle to drop the pressure inside of the nozzle, thereby forming large droplets. The discharge pressure is thereby reduced by about half as compared with before the dilution is introduced into the nozzle. Examples of the pre-orifice nozzle include DR110-10, UR110-05, UR110-06, UR110-08, and UR110-10 manufactured by Wilger Company and 1/4TTJ08 Turf Jet and 1/4TTJ04 Turf Jet manufactured by Teejet Company.

The discharge pattern is preferably, though not particularly limited to, a flat fan type. As an example of the pattern excluding the flat fan type, a cone type is given.

The dicot crop seeds are sown in the cultivation area using a usual method. In the method of the present invention, the compound of the present invention may be applied in the cultivation area before sowing dicot crop seeds or may be applied when and/or after sowing dicot crop seeds. Specifically, the number of applications of the compound of the present invention is any one of 1 to 3. When the number of applications is 1, the compound is applied once before sowing, once when sowing, or once after sowing. When the number of applications is 2, the compound is applied twice excluding the time before sowing, twice excluding the time when sowing, or twice excluding the time after sowing. When the number of applications is 3, the compound is applied thrice, that is, before, when, and after sowing.

When applying the compound of the present invention, before sowing, the compound is applied just before or within 50 days, preferably within 30 days, more preferably within 20 days, and even more preferably within 10 days before sowing.

When applying the compound of the present invention after sowing, the compound is usually applied during a period just after sowing and before blooming. The compound is more preferably applied during a period just after sowing and before emerging or during a period between 1 and 6 leaf stages of the dicot crop. When applying the compound of the present invention to perform foliar treatment during a period between 1 and 6 leaf stages, the compound of the present invention may be used in combination with one or more compounds selected from the following compound group B. Alternatively, the foliar treatment using the compound of the present invention and the foliar treatment using one or more compounds selected from the following compound group B may be performed sequentially. In the case of performing the foliar treatment using the compound of the present invention and the foliar treatment using one or more compounds selected from the following compound group B sequentially, there is no particular limitation to the order.

The case where the compound of the present invention is applied when sowing implies the case where a seeding machine is integrated with a spraying machine.

The dicot crop seeds may be treated with one or more compounds selected from the group consisting of specific insecticidal compounds, nematicidal compounds, fungicidal compounds, and plant growth regulators. Specifically, the compound group is a group A consisting of a neonicotinoid type compound, diamide type compound, carbamate type compound, organic phosphorous type compound, biological nematicidal compound, other insecticidal compound and nematicidal compound, azole type compound, strobilurin type compound, metalaxyl type compound, SDHI compound, other fungicidal compound, or plant growth regulator.

As the neonicotinoid type compound applied to treat seeds in the method of the present invention, the following compounds are given as examples:

clothianidin, imidacloprid, nitenpyram, acetamiprid, thiamethoxam, flupyradifurone, thiacloprid and dinotefuran.

As the diamide type compound applied to treat seeds in the method of the present invention, the following compounds are given as examples:

flubendiamide, chlorantraniliprole, cyantraniliprole, cyclaniliprole, tetraniliprole and cyhalodiamide.

As the carbamate type compound applied to treat seeds in the method of the present invention, the following compounds are given as examples:

aldicarb, oxamyl, thiodicarb, carbofuran, carbosulfan and dimethoate.

As the organic phosphorous type compound applied to treat seeds in the method of the present invention, the following compounds are given as examples:

fenamiphos, imicyafos, fensulfothion, terbufos, fosthiazate, phosphocarb, dichlofenthion, isamidofos, isazophos, ethoprophos, cadusafos, chlorpyrifos, heterofos, mecarphon, phorate, thionazin, triazophos, diamidafos, fosthietan and phosphamidon.

As the biological nematicidal compound applied to treat seeds in the method of the present invention, the following compounds are given as examples:

Harpin Protein, Pasteuria nishizawae, Pasteuria penetrans, Pasteuria usage, Myrothecium verrucaria, Burholderia cepacia, Bacillus chitonosporus, Paecilomyces lilacinus, Bacillus amyloliquefaciens, Bacillus firmus, Bacillus subtillis, Bacillus pumulis, Trichoderma harzianum, Hirsutella rhossiliensis, Hirsutella minnesotensis, Verticillium chlamydosporum and Arthrobotrys dactyloides.

As the other insecticidal compound applied to treat seeds in the method of the present invention, the following compounds are given as examples:

fipronil, ethiprole, beta-cyfluthrin, tefluthrin, chlorpyrifos, abamectin, spirotetramat, tioxazafen, fluazaindolizine, fluensulfone, sulfoxaflor, triflumezopyrim, dicloromezotiaz, broflanilide and fluxametamide.

As the azole type compound applied to treat seeds in the method of the present invention, the following compounds are given as examples:

azaconazole, bitertanol, bromuconazole, cyproconazole, difenoconazole, diniconazole, epoxyconazole, fenbuconazole, fluquinconazole, flusilazole, flutriafol, hexaconazole, imibenconazole, ipconazole, metconazole, myclobutanil, penconazole, propiconazole, prothioconazole, simeconazole, tebuconazole, tetraconazole, triadimenol, triticonazole, fenarimol, nuarimol, pyrifenox, imazalil, oxpoconazole fumarate, efurazoate, prochloraz, triflumizole, ipfentrifluconazole, and mefentrifluconazole.

As the strobilurin type compound applied to treat seeds in the method of the present invention, the following compounds are given as examples:

kresoxim-methyl, azoxystrobin, trifloxystrobin, fluoxastrobin, picoxystrobin, pyraclostrobin, dimoxystrobin, pyribencarb, metominostrobin, orysastrobin and mandestrobin.

As the metalaxyl type compound applied to treat seeds in the method of the present invention, the following compounds are given as examples:

Metalaxyl and metalaxyl-M or mefenoxam.

As the SDHI compound applied to treat seeds in the method of the present invention, the following compounds are given as examples:

sedaxane, penflufen, carboxin, boscalid, furametpyr, flutolanil, fluxapyroxad, isopyrazam, fluopyram, isofetamid, pyraziflumid, pydiflumetofen, fluindapyr, inpyrfluxam, thifluzamide, isoflucypram and pydiflumetofen.

As the plant growth regulator applied to treat seeds in the method of the present invention, the following compounds are given as examples:

Ethephon, chlormequat-chloride, mepiquat-chloride, 4-oxo-4-(2-phenyethyl)aminobutylic acid (hereinafter also referred to as “compound 2”), root-nodule bacteria such as Bradyrhizobium japonicum (for example, strain TA11), and mycorrhizal fungi such as Rhizophagus irregularis (formerly, Glomus intraradices, for example, strain DAOM 197198).

As the other fungicidal compound applied to treat seeds in the method of the present invention, the following compounds are given as examples:

Tolclofos-methyl, thiram, captan, carbendazim, thiophanate-methyl, mancozeb, thiabendazole, isotianil, triazoxide, picarbutrazox, fluoxapiprolin, and oxathiapiprolin.

These compounds used to treat seeds in the method of the present invention are known compounds and can be synthesized based on already published technical documents, and also, commercially available formulations and standard products can be obtained from the market to use.

In the cultivation of dicot crops, one or more compounds selected from the group consisting of insecticidal compounds and fungicidal compounds may be applied to foliar treatment in the growing period of the dicot crops. Specifically, the compound group is a group B consisting of a strobilurin type compound, azole type compound, SDHI compound, pyrethroid type compound, benzoylphenylurea compound, organic phosphorous type insecticidal compound, neonicotinoid type compound, and diamide compound.

Examples of the strobilurin type compound used for the foliar treatment in the growing period of a dicot crop in the method of the present invention include the following compounds:

pyraclostrobin, azoxystrobin, mandestrobin, trifloxystrobin, and picoxystrobin.

Examples of the azole type compound used for the foliar treatment in the growing period of a dicot crop in the method of the present invention include the following compounds:

prothioconazole, epoxiconazole, tebuconazole, cyproconazole, propiconazole, metconazole, bromuconazolee, tetraconazole, triticonazole, ipfentrifluconazole and mefentrifluconazole.

Examples of the SDHI compound used when the foliar treatment is performed in the growing period of a dicot crop in the method of the present invention include the following compounds:

benzovindiflupyr, bixafen, fluxapyroxad, fluindapyr, inpyrfluxam, isoflucypram, pydiflumetofen and pyraziflumid.

Examples of the other fungicidal compound used when the foliar treatment is performed in the growing period of a dicot crop in the method of the present invention include the following compounds:

tolclofos-methyl and ethaboxam.

Examples of the pyrethroid type compound used when the foliar treatment is performed in the growing period of a dicot crop in the method of the present invention include the following compounds:

bifenthrin, lambda-cyhalothrin, gamma-cyhalothrin, cypermethrin, fenpropathrin, etofenprox, silafluofen and esfenvalerate.

Examples of the benzoylphenylurea compound used when the foliar treatment is performed in the growing period of a dicot crop in the method of the present invention include the following compounds:

Teflubenzuron and triflumuron.

Examples of the organic phosphorous type insecticidal compound used when the foliar treatment is performed in the growing period of a dicot crop in the method of the present invention include the following compounds:

Acephate and methomyl.

Examples of the neonicotinoid type compound used when the foliar treatment is performed in the growing period of a dicot crop in the method of the present invention include the following compounds:

imidacloprid, clothianidin, thiamethoxam, acetamiprid, thiacloprid, dinotefuran and nitenpyram.

Examples of the diamide type compound used when the foliar treatment is performed in the growing period of a dicot crop in the method of the present invention include the following compounds:

flubendiamide, chlorantraniliprole, cyantraniliprole, cyclaniliprole, tetraniliprole and cyhalodiamide.

Examples of the other insecticidal compound used when the foliar treatment is performed in the growing period of a dicot crop in the method of the present invention include the following compounds:

sulfoxaflor, flupyradifurone, triflumezopyrim, dicloromezotiaz, dimpropyridaz and broflanilide.

These compounds used when the foliar treatment is performed in the method of the present invention are known compounds and can be synthesized based on already known patent documents, and also, commercially available formulations and standard products can be obtained from the market to use.

One or more compounds selected from the above compound group A used when the seed treatment is performed in the method of the present invention are usually mixed with a carrier such as a solid carrier or liquid carrier, to which a formulation auxiliary such as a surfactant is further added according to the need to make a formulation. The formulation type is preferably an aqueous liquid suspension. In this case, formulations each containing a single ingredient may be used either singly or in combinations of two or more or formulations each containing two or more ingredients may be used.

The amount of the compound to be used for the seed treatment is in a range of generally 0.2 to 5000 g and preferably 0.5 to 1000 g per 100 kg of seeds. Examples of the method of seed treatment include a method in which the seed is powder-coated with a formulation containing the compound, a method in which the seed is dipped in the formulation containing the compound, a method in which the formulation containing the compounds is sprayed onto the seed, and a method in which the seed is coated with a mixture of the compound and the carrier.

One or more compounds selected from the above compound group B used when the foliar treatment is performed in the growing period of a dicot crop in the method of the present invention are usually mixed with a carrier such as a solid carrier or liquid carrier, to which a formulation auxiliary such as a surfactant is further added according to the need to make a formulation. The formulation type is preferably an emulsifiable concentrate, aqueous liquid suspension concentrate, or soluble liquid.

When one or more compounds selected from the above compound group B are used to perform foliar treatment in the growing period of a dicot crop, the compounds are used for the treatment preferably 10 to 120 days and more preferably 21 to 90 days after sowing. At this time, the number of compounds selected from the compound group B may be either one or two or more. When a plurality of compounds are used for foliar treatment, a plurality of formulations singly containing each compound as an active ingredient may be used. In this case, these formulations are used simultaneously as a mixture or sequentially for the treatment. When a plurality of compounds are used for the foliar treatment, a formulation containing a plurality of compounds as active ingredients may be used.

The amount of one or more compounds selected from the above compound group B used for the foliar treatment is generally 5 to 5000 g, preferably 20 to 2000 g, and more preferably 500 to 1500 g per 10000 m². In this case, when the foliar treatment is performed using one or more compounds selected from the above compound group B, an adjuvant may be mixed with the compound.

In the method of the present invention, weeds occurring in the cultivation of dicot crops may be controlled together with volunteer corn plants by applying the compound of the present invention, applying a mixture of the compound of the present invention with other herbicides, or applying sequentially the compound of the present invention and other herbicides. Examples of the weed species that are controlled together with volunteer corn plants include, but not limited to, the following weeds:

Urticaceae: Urtica urens

Polygonaceae: Polygonum convolvulus, Polygonum lapathifolium, Polygonum pensylvanicum, Polygonum persicaria, Polygonum longisetum, Polygonum aviculare, Polygonum arenastrum, Polygonum cuspidatum, Rumex japonicus, Rumex crispus, Rumex obtusifolius, Rumex acetosa

Portulacaceae: Portulaca oleracea

Caryophyllaceae: Stellaria media, Stellaria aquatica, Cerastium holosteoides, Cerastium glomeratum, Spergula arvensis, Silene gallica

Molluginaceae: Mollugo verticillata

Chenopodiaceae: Chenopodium album, Chenopodium ambrosioides, Kochia scoparia, Salsola kali, Atriplex spp.

Amaranthaceae: Amaranthus retroflexus, Amaranthus viridis, Amaranthus lividus, Amaranthus spinosus, Amaranthus hybridus, Amaranthus palmeri, Amaranthus patulus, Amaranthus tuberculatus=Amaranthus rudis=Amaranthus tamariscinus), Amaranthus blitoides, Amaranthus deflexus, Amaranthus quitensis, Alternanthera philoxeroides, Alternanthera sessilis, Alternanthera tenella

Papaveraceae: Papaver rhoeas, Papaver dubium, Argemone mexicana

Brassicaceae: Raphanus raphanistrum, Raphanus sativus, Sinapis arvensis, Capsella bursa-pastoris, Brassica juncea, Brassica napus, Descurainia pinnata, Rorippa islandica, Rorippa sylvestris, Thlaspi arvense, Myagrum rugosum, Lepidium virginicum, Coronopus didymus

Capparaceae: Cleome affinis

Fabaceae: Aeschynomene indica, Aeschynomene rudis, Sesbania exaltata, Cassia obtusifolia, Cassia occidentalis, Desmodium tortuosum, Desmodium adscendens, Desmodium illinoense, Trifolium repens, Pueraria lobata, Vicia angustifolia, Indigofera hirsuta, Indigofera truxillensis, Vigna sinensis

Oxalidaceae: Oxalis corniculata, Oxalis strica, Oxalis oxyptera

Geraniaceae: Geranium carolinense, Erodium cicutarium

Euphorbiaceae: Euphorbia helioscopia, Euphorbia maculata, Euphorbia humistrata, Euphorbia esula, Euphorbia heterophylla, Euphorbia brasiliensis, Acalypha australis, Croton glandulosus, Croton lobatus, Phyllanthus corcovadensis, Ricinus communis

Malvaceae: Abutilon theophrasti, Sida rhombiforia, Sida cordifolia, Sida spinosa, Sida glaziovii, Sida santaremnensis, Hibiscus trionum, Anoda cristata, Malvastrum coromandelianum

Onagraceae: Ludwigia epilobioides, Ludwigia octovalvis, Ludwigia decurre, Oenothera biennis, Oenothera laciniata

Sterculiaceae: Waltheria indica

Violaceae: Viola arvensis, Viola tricolor

Cucurbitaceae: Sicyos angulatus, Echinocystis lobata, Momordica charantia

Lythraceae: Ammannia multiflora, Ammannia auriculata, Ammannia coccinea, Lythrum salicaria, Rotala indica

Elatinaceae: Elatine triandra, Elatine californica

Apiaceae: Oenanthe javanica, Daucus carota, Conium maculatum

Araliaceae: Hydrocotyle sibthorpioides, Hydrocotyle ranunculoides

Ceratophyllaceae: Ceratophyllum demersum

Cabombaceae: Cabomba caroliniana

Haloragaceae: Myriophyllum aquaticum, Myriophyllum verticillatum, Myriophyllum spicatum, Myriophyllum heterophyllum, and the like

Sapindaceae: Cardiospermum halicacabum

Primulaceae: Anagallis arvensis

Asclepiadaceae: Asclepias syriaca, Ampelamus albidus

Rubiaceae: Galium aparine, Galium spurium var. echinospermon, Spermacoce latifolia, Richardia brasiliensis, Borreria alata

Convolvulaceae: Ipomoea nil, Ipomoea hederacea, Ipomoea purpurea, Ipomoea hederacea var. integriuscula, Ipomoea lacunosa, Ipomoea triloba, Ipomoea acuminata, Ipomoea hederifolia, Ipomoea coccinea, Ipomoea quamoclit, Ipomoea grandifolia, Ipomoea aristolochiafolia, Ipomoea cairica, Convolvulus arvensis, Calystegia hederacea, Calystegia japonica, Merremia hedeacea, Merremia aegyptia, Merremia cissoides, Jacquemontia tamnifolia

Boraginaceae: Myosotis arvensis

Lamiaceae: Lamium purpureum, Lamium amplexicaule, Leonotis nepetaefolia, Hyptis suaveolens, Hyptis lophanta, Leonurus sibiricus, Stachys arvensis

Solanaceae: Datura stramonium, Solanum nigrum, Solanum americanum, Solanum ptycanthum, Solanum sarrachoides, Solanum rostratum, Solanum aculeatissimum, Solanum sisymbriifolium, Solanum carolinense, Physalis angulata, Physalis sub glabrata, Nicandra physaloides

Scrophulariaceae: Veronica hederaefolia, Veronica persica, Veronica arvensis, Lindernia procumbens, Lindernia dubia, Lindernia angustifolia, Bacopa rotundifolia, Dopatrium junceum, Gratiola japonica

Plantaginaceae: Plantago asiatica, Plantago lanceolata, Plantago major, Callitriche palustris

Asteraceae: Xanthium pensylvanicum, Xanthium occidentale, Xanthium italicum, Helianthus annuus, Matricaria chamomilla, Matricaria perforata, Chrysanthemum segetum, Matricaria matricarioides, Artemisia princeps, Artemisia vulgaris, Artemisia verlotorum, Solidago altissima, Taraxacum officinale, Galinsoga ciliata, Galinsoga parviflora, Senecio vulgaris, Senecio brasiliensis, Senecio grisebachii, Conyza bonariensis, Conyza smatrensis, Conyza canadensis, Ambrosia artemisiaefolia, Ambrosia trifida, Bidens tripartita, Bidens pilosa, Bidens frondosa, Bidens sub alternans, Cirsium arvense, Cirsium vulgare, Silybum marianum, Carduus nutans, Lactuca serriola, Sonchus oleraceus, Sonchus asper, Wedelia glauca, Melampodium perfoliatum, Emilia sonchifolia, Tagetes minuta, Blainvillea latifolia, Tridax procumbens, Porophyllum ruderale, Acanthospermum australe, Acanthospermum hispidum, Cardiospermum halicacabum, Ageratum conyzoides, Eupatorium perfoliatum, Eclipta alba, Erechtites hieracifolia, Gamochaeta spicata, Gnaphalium spicatum, Jaegeria hirta, Parthenium hysterophorus, Siegesbeckia orientalis, Soliva sessilis, Eclipta prostrata, Eclipta alba, Centipeda minima

Alismataceae: Sagittaria pygmaea, Sagittaria trifolia, Sagittaria sagittifolia, Sagittaria montevidensis, Sagittaria aginashi, Alisma canaliculatum, Alisma plantago-aquatica

Limnocharitaceae: Limnocharis flava

Hydrocharitaceae: Limnobium spongia, Hydrilla verticillata, Najas guadalupensis

Araceae: Pistia stratiotes

Lemnaceae: Lemna aoukikusa, Spirodela polyrhiza, Wolffia spp.

Potamogetonaceae: Potamogeton distinctus, Potamogeton crispus, Potamogeton illinoensis, Stuckenia pectinata, and the like

Liliaceae: Allium canadense, Allium vineale, Allium macrostemon

Pontederiaceae: Eichhornia crassipes, Heteranthera limosa, Monochoria korsakowii, Monochoria vaginalis

Commelinaceae: Commelina communis, Commelina bengharensis, Commelina erecta, Murdannia keisak

Poaceae: Echinochloa crus-galli, Echinochloa oryzicola, Echinochloa crus-galli var formosensis, Echinochloa oryzoides, Echinochloa colona, Echinochloa crus-pavonis, Setaria viridis, Setaria faberi, Setaria glauca, Setaria geniculata, Digitaria ciliaris, Digitaria sanguinalis, Digitaria horizontalis, Digitaria insularis, Eleusine indica, Poa annua, Poa trivialis, Poa pratensis, Alopecurus aequalis, Alopecurus myosuroides, Avena fatua, Sorghum halepense, Sorghum vulgare, Agropyron repens, Lolium multiflorum, Lolium perenne, Lolium rigidum, Bromus catharticus, Bromus sterilis, Bromus japonicus, Bromus secalinus, Bromus tectorum, Hordeum jubatum, Aegilops cylindrica, Phalaris arundinacea, Phalaris minor, Apera spica-venti, Panicum dichotomiflorum, Panicum texanum, Panicum maximum, Brachiaria platyphylla, Brachiaria ruziziensis, Brachiaria plantaginea, Brachiaria decumbens, Brachiaria brizantha, Brachiaria humidicola, Cenchrus echinatus, Cenchrus pauciflorus, Eriochloa villosa, Pennisetum setosum, Chloris gayana, Chloris virgata, Eragrostis pilosa, Rhynchelitrum repens, Dactyloctenium aegyptium, Ischaemum rugosum, Isachne globosa, Oryza sativa, Paspalum notatum, Paspalum maritimum, Paspalum distichum, Pennisetum clandestinum, Pennisetum setosum, Rottboellia cochinchinensis, Leptochloa chinensis, Leptochloa fascicularis, Leptochloa filiformis, Leptochloa panicoides, Leersia japonica, Leersia sayanuka, Leersia oryzoides, Glyceria leptorrhiza, Glyceria acutiflora, Glyceria maxima, Agrostis gigantea, Agrostis stolonifera, Cynodon dactylon, Dactylis glomerata, Eremochloa ophiuroides, Festuca arundinacea, Festuca rubra, Imperata cylindrica, Miscanthus sinensis, Panicum virgatum, Zoysia japonica

Cyperaceae: Cyperus microiria, Cyperus iria, Cyperus compressus, Cyperus difformis, Cyperus flaccidus, Cyperus globosus, Cyperus nipponics, Cyperus odoratus, Cyperus serotinus, Cyperus rotundus, Cyperus esculentus, Kyllinga gracillima, Kyllinga brevifolia, Fimbristylis miliacea, Fimbristylis dichotoma, Eleocharis acicularis, Eleocharis kuroguwai, Schoenoplectiella hotarui, Schoenoplectiella juncoides, Schoenoplectiella wallichii, Schoenoplectiella mucronatus, Schoenoplectiella triangulatus, Schoenoplectiella nipponicus, Schoenoplectiella triqueter, Bolboschoenus koshevnikovii, Bolboschoenus fluviatilis

Equisetaceae: Equisetum arvense, Equisetum palustre

Salviniaceae: Salvinia natans

Azollaceae: Azolla japonica, Azolla imbricata

Marsileaceae: Marsilea quadrifolia.

Other weeds: filamentous algae (Pithophora and Cladophora), mosses, bryophyte, hornwort, cyanobacteria, bracken, and suckers of perennial crops (for example, kernel fruits, stone fruits, berries, nuts, citrus fruits, hop, and grape).

There is no particular limitation to the intraspecific variation in weeds which can be controlled by the method of the present invention. In other words, the above weeds may also have a trait of being deteriorated in sensitivity to specific herbicides and a trait of being resistant to these herbicides. The deterioration in sensitivity and the resistance may be due to either a mutation at a target site (target-site mutation) or a factor that is not a mutation at a site of action (non-target-site mutation). Examples of the non-target-site mutation include an increase in metabolism, malabsorption, transition failure, and external excretion. Examples of the factor promoting metabolism include those caused by increase in the activities of metabolases such as cytochrome P450 monooxygenase, allylacylamidase, esterase, and glutathione S-transferase. Examples of the factor of the external excretion include those caused by the transportation driven by an ABC transporter into vacuoles. Examples of the herbicide resistant weeds are trait-wisely shown below.

Glyphosate Resistance:

Target-site mutations include those in EPSPS genes causing amino acid substitutions such as Thr102Ile, Pro106Ser, Pro106Ala, and Pro106Leu. Particularly, glyphosate resistant weeds such as Eleusine indica, Lolium multiflorum, Lolium rigidum, Digitaria insularis, Amaranthus tuberculatus, and Echinochloa colona containing one or a plurality of these mutations (for example, a double mutation of Thr102Ile and Pro106Ser) are efficiently controlled. Another example of target-site mutation is those caused by increased EPSP gene copy number, and glyphosate resistant weeds such as Amaranthus palmeri, Amaranthus tuberculatus, and Kochia scoparia which particularly have the above mutation are efficiently controlled. As an example of non-target-site mutation, glyphosate-resistant Conyza canadensis, Conyza smatrensis, and Conyza bonariensis in which an ABC transporter is involved are also efficiently controlled.

ALS Inhibitor Resistance:

Target-site mutations include those in ALS genes causing amino acid substitutions such as Ala122Thr, Ala122Val, Ala122Tyr, Pro197Ser, Pro197His, Pro197Thr, Pro197Arg, Pro197Leu, Pro197Gln, Pro197Ala, Pro197Ile, Ala205Val, Ala205Phe, Asp376Glu, Asp376Gln, Arg377His, Trp574Leu, Trp574Gly, Trp574Met, Ser653Thr, Ser653Thr, Ser653Asn, Ser635Ile, Gly654Glu, and Gly645Asp. Particularly, Amaranthus palmeri and Amaranthus tuberculatus having one or more of these mutations are efficiently controlled.

ACCase Inhibitor Resistance:

Target-site mutations include those in ACCase genes causing amino acid substitutions such as Ile1781Leu, Ile1781Val, Ile1781Thr, Trp1999Cys, Trp1999Leu, Ala2004Val, Trp2027Cys, Ile2041Asn, Ile2041Val, Asp2078Gly, and Cys2088Arg. Particularly, Lolium multiflorum having one or more of these mutations are efficiently controlled.

PPO Inhibitor Resistance:

Weeds which are control targets in the method of the present invention may have, in each PPO, one or more mutations selected from an Arg128Leu mutation, Arg128Met mutation, Arg128Gly mutation, Arg128His mutation, Gly210 deletion mutation, Gly144Glu mutation, Ser149Ile mutation, and Gly399Ala mutation as target-site mutations. Although PPO1 and PPO2 are usually included in PPO of weeds, the above mutation may be contained in any one of PPO1 and PPO2 or both. The case where the mutation is contained in PPO2 is preferable. Particularly, Amaranthus palmeri, Amaranthus tuberculatus, and Lolium multiflorum having one or more of these mutations are efficiently controlled.

Auxin-Type Herbicide Resistance:

Target-site mutations include those in AUX/IAA gene's degron region causing an amino acid substitution of Gly-Asn. Particularly, Amaranthus palmeri, Amaranthus tuberculatus, and Kochia scoparia having the mutation are efficiently controlled.

HPPD Inhibitor Resistance:

As non-target-site mutations, Amaranthus palmeri and Amaranthus tuberculatus resistant to HPPD inhibitors in which P450 monooxygenase or glutathione S-transferase is involved are also efficiently controlled.

PSII Inhibitor Resistance:

Target-site mutations include those in psbA genes causing amino acid substitutions such as Val219Ile, Ser264Gly, Ser264Ala, Phe274Val. Particularly, Amaranthus palmeri, and Amaranthus tuberculatus having one or more of these mutations are efficiently controlled. PSII inhibitor resistant Amaranthus palmeri, and Amaranthus tuberculatus, in which allylacylamidase, P450 monooxygenase or glutathione 5-transferase is involved are also efficiently controlled.

Glufosinate Resistance:

Target-site mutations include those in glutamine synthase genes causing an amino acid substitution such as Asp171Asn. Particularly, Amaranthus palmeri and Amaranthus tuberculatus having the mutations are efficiently controlled. Glufosinate-resistant Amaranthus palmeri, and Amaranthus tuberculatus, in which P450 monooxygenase or glutathione S-transferase is involved are also efficiently controlled.

Weeds may be resistant to one or more herbicides. For example, Amaranthus tuberculatus resistant to glyphosate, 2,4-D, PPO inhibitors, ALS inhibitors, HPPD inhibitors, and PSII inhibitors is known and is efficiently controlled in the method of the present invention.

In the method of the present invention, one or more other herbicides, plant growth regulators, and safeners may be used in combination with the compound of the present invention. Here, the description “used in combination with” includes tank-mix, premix, and sequential treatments which may be performed in a random order without any particular limitation to its order.

Examples of the herbicides, plant growth regulators, and safeners which may be used in combination with the compound of the present invention include the following compounds.

Herbicides: 2,3,6-TBA (2,3,6-trichlorobenzoic acid), 2,3,6-TBA-dimethylammonium, 2,3,6-TBA lithium salt, 2,3,6-TBA potassium salt, 2,3,6-TBA sodium salt, 2,4-D, 2,4-D choline salt, 2,4-D BAPMA salt (2,4-D N,N-bis(3-aminopropyl)methylamine salt), 2,4-D-2-butoxypropyl, 2,4-D-2-ethylhexyl, 2,4-D-3-butoxypropyl, 2,4-D ammonium, 2,4-D-butotyl, 2,4-D-butyl, 2,4-D-diethylammonium, 2,4-D-dimethylammonium, 2,4-D diolamine salt, 2,4-D-dodecylammonium, 2,4-D-ethyl, 2,4-D-heptylammonium, 2,4-D-isobutyl, 2,4-D-isooctyl, 2,4-D-isopropyl, 2,4-D-isopropylammonium, 2,4-D-lithium salt, 2,4-D meptyl, 2,4-D-methyl, 2,4-D-octyl, 2,4-D-pentyl, 2,4-D-propyl, 2,4-D-sodium salt, 2,4-D-tefuryl, 2,4-D-tetradecylammonium, 2,4-D-triethylammonium, 2,4-D-tris(2-hydroxypropyl)ammonium, 2,4-D-trolamine salt, 2,4-DB, 2,4-DB choline salt, 2,4-DB BAPMA salt (2,4-DB N,N-bis(3-aminopropyl)methylamine salt), 2,4-DB-butyl, 2,4-DB-dimethylammonium, 2,4-DB-isoctyl, 2,4-DB-potassium salt, 2,4-DB sodium salt, acetochlor, acifluorfen, acifluorfen-sodium salt, aclonifen, ACN(2-amino-3-chloronaphthalene-1,4-dione), alachlor, allidochlor, alloxydim, ametryn, amicarbazone, amidosulfuron, aminocyclopyrachlor, aminocyclopyrachlormethyl, aminocyclopyrachlor-potassium salt, aminopyralid (aminopyralid), aminopyralid choline salt, aminopyralid-potassium salt, aminopyralidtris(2-hydroxypropyl)ammonium, amiprophos-methyl, amitrole, anilofos, asulam, atrazine, azafenidin, azimsulfuron, beflubutamid, benazolin-ethyl, bencarbazone, benfluralin, benfuresate, bensulfuron, bensulfuron-methyl, bensulide, bentazon, benthiocarb, benzfendizone, benzobicyclon, benzofenap, benzthiazuron, bialafos (bialafos or bialaphos), bicyclopyrone, bifenox, bispyribac, bispyribac-sodium salt, bixlozone, bromacil, bromobutide, bromofenoxim, bromoxynil, bromoxynil-octanoate, butachlor, butafenacil, butamifos, butralin, butroxydim, butylate, cafenstrole, carbetamide, carfentrazone, carfentrazone-ethyl, chlomethoxyfen, chloramben, chloridazon, chlorimuron, chlorimuron-ethyl, chlorobromuron, chlorotoluron, chloroxuron, chlorpropham, chlorsulfuron, chlorthal-dimethyl, chlorthiamide, cinidon, cinidonethyl, cinmethylin, cinosulfuron, clodinafop, clodinafop-propargyl, clomazone, clomeprop, clopyralid, clopyralid choline salt, clopyralid-methyl, clopyralid-olamine, clopyralid-potassium salt, clopyralid-tris (2-hydroxypropyl)ammonium, cloransulam, cloransulam-methyl, cumyluron, cyanazine, cyclopyranil, cycloate, cyclopyrimorate, cyclosulfamuron, cycloxydim, cyhalofop, cyhalofop-butyl, daimuron, dalapon, dazomet, desmedipham, desmetryn, di-allate, dicamba, dicamba choline salt, dicamba BAPMA salt (dicamba N,N-bis(3-aminopropyl)methylamine salt), dicambatetrabutlyammonium salt (dicamba TBA salt), dicamba-tetrabutlyphosphonium salt (dicamba TBP salt), dicamba-trolamine salt, dicamba-diglycolamine salt, dicambadimethylammonium, dicamba-diolamine salt, dicamba-isopropylammonium, dicambamethyl, dicamba-olamine salt, dicamba-potassium salt, dicamba-sodium salt, dichlobenil, dichlorprop, dichlorprop choline salt), dichlorprop BAPMA salt (dichlorprop N,N-bis(3-aminopropyl)methylamine salt), dichlorprop-2-ethylhexyl, dichlorprop-butotyl, dichlorprop-dimethylammonium, dichlorprop-ethylammonium, dichlorprop-isoctyl, dichlorprop-methyl, dichlorprop-P, dichlorprop-P choline salt, dichlorprop-P BAPMA salt (dichlorprop-P N,N-bis(3-aminopropyl)methylamine salt), dichlorprop-P-2-ethylhexyl, dichlorprop-P-dimethylammonium, dichlorproppotassium, dichlorprop-sodium salt, diclofop, diclofop-methyl, diclosulam, difenoxuron, difenzoquat, diflufenican, diflufenzopyr, diflufenzopyr-sodium salt, dimefuron, dimepiperate, dimethachlor, dimethametryn, dimethenamid, dimethenamidP, dimepiperate, dinitramine, dinoseb, dinoterb, diphenamid, diquat, diquat-dibromide, DSMA (disodium methylarsonate), dithiopyr, diuron, DNOC (2-methyl-4,6-dinitrophenol), esprocarb, ethalfluralin, ethametsulfuron, ethametsulfuron-methyl, ethidimuron, ethofumesate, ethoxyfen-ethyl, ethoxysulfuron, etobenzanid, fenoxaprop, fenoxaprop-ethyl, fenoxaprop-P, fenoxaprop-P-ethyl, fenoxasulfone, fenquinotrione, fentrazamide, fenuron, flamprop-M, flazasulfuron, florasulam, florpyrauxifen, florpyrauxifen-benzyl, fluazolate, flucarbazone, flucarbazone-sodium salt, flucetosulfuron, flufenacet, flufenpyr, flufenpyr-ethyl, flumetsulam, flumiclorac, flumiclorac-pentyl, fluometuron, fluoroglycofen-ethyl, flupoxam, flupropanate, flupyrsulfuron, flupyrsulfuron-methyl-sodium, flurenol, fluridone, flurochloridone, fluroxypyr, fluroxypyr-meptyl, flurtamone, fluthiacet, fluthiacet-methyl, fomesafen, fomesafen-sodium, foramsulfuron, fosamine, glufosinate, glufosinate-ammonium salt, glufosinate-P, glufosinate-P-ammonium salt, glufosinate-P-sodium salt, glyphosate, glyphosate choline salt, glyphosate guanidine derivative salts, glyphosate isopropylamine salt, glyphosate BAPMA salt (glyphosate N,N-bis(3-aminopropyl)methylamine salt), glyphosate-ammonium salt, glyphosatediammonium salt, glyphosate-potassium salt, glyphosate-sodium salt, glyphosatetrimethylsulfonium salt, halauxifen, halauxifen-methyl, halosafen, halosulfuron, halosulfuron-methyl, hexazinone, imazamethabenz, imazamethabenz-methyl, imazamox, imazamox-ammonium salt, imazapic, imazapic-ammonium salt, imazapyr, imazapyrisopropylammonium salt, imazaquin, imazaquin-ammonium salt, imazethapyr, imazethapyr-ammonium salt, imazosulfuron, indanofan, indaziflam, iodosulfuron, iodosulfuron-methyl-sodium, iofensulfuron, iofensulfuron-sodium, ioxynil, ioxyniloctanoate, ipfencarbazone, isoproturon, isouron, isoxaben, isoxachlortole, isoxaflutole, lactofen, lenacil, linuron, maleic acid hydrazide, MCPA (2-(4-chloro-2-methylphenoxy)acetic acid), MCPA choline salt, MCPA BAPMA salt (MCPA N,N-bis(3-aminopropyl)methylamine salt), MCPA 2-ethylhexyl, MCPA butotyl (MCPA-butotyl), MCPA butyl, MCPA-dimethylammonium, MCPA diolamine salt, MCPA-ethyl, MCPA isobutyl, MCPA-isoctyl, MCPA-isopropyl, MCPA-methyl, MCPA-olamine salt, MCPA-sodium salt, MCPA-trolamine salt, MCPB (4-(4-chloro-2-methylphenoxy)butanoic acid), MCPB choline salt, MCPB BAPMA salt (MCPB N,N-bis(3-aminopropyl)methylamine salt), MCPB-ethyl, MCPB-methyl, MCPB-sodium salt, mecoprop, mecoprop choline salt, mecoprop BAPMA salt (mecoprop N,N-bis(3-aminopropyl)methylamine salt), mecoprop-2-ethylhexyl, mecoprop-dimethylammonium, mecoprop-diolamine salt, mecoprop-ethadyl, mecoprop-isoctyl, mecoprop-methyl, mecoprop-potassium salt, mecoprop-sodium salt, mecoprop-trolamine salt, mecoprop-P, mecoprop-P choline salt, mecopropP-2-ethylhexyl, mecoprop-P-dimethylammonium, mecoprop-P-isobutyl, mecopropP-potassium salt, mefenacet, mesosulfuron, mesosulfuron-methyl, mesotrione, metam, metamifop, metamitron, metazachlor, metazosulfuron, methabenzthiazuron, methiozolin, methyl-daymuron, metobromuron, metolachlor, metosulam, metoxuron, metribuzin, metsulfuron, metsulfuron-methyl, molinate, monolinuron, naproanilide, napropamide, napropamide-M, naptalam, neburon, nicosulfuron, norflurazon, oleic acid, orbencarb, orthosulfamuron, oryzalin, oxadiargyl, oxadiazon, oxasulfuron, oxaziclomefone, oxyfluorfen, paraquat, paraquat-dichloride, pebulate, pelargonic acid, pendimethalin, penoxsulam, pentanochlor, pentoxazone, pethoxamid, phenisopham, phenmedipham, picolinafen, pinoxaden, piperophos, pretilachlor, primisulfuron, primisulfuron-methyl, prodiamine, profluazol, profoxydim, prometon, prometryn, propachlor, propanil, propaquizafop, propazine, propham, propisochlor, propoxycarbazone, propoxycarbazone-sodium salt, propyrisulfuron, propyzamide, prosulfocarb, prosulfuron, pyraclonil, pyraflufen-ethyl, pyrasulfotole, pyrazolynate, pyrazosulfuron, pyrazosulfuron-ethyl, pyrazoxyfen, pyribenzoxim, pyributicarb, pyridafol, pyridate, pyriftalid, pyriminobac, pyriminobac-methyl, pyrimisulfan, pyrithiobac, pyrithiobac-sodium salt, pyroxasulfone, pyroxsulam, quinclorac, quinmerac, rimsulfuron, EPTC (S-ethyl N,N-dipropylcarbamothioate), siduron, simazine, simetryn, S-metolachlor, MSMA (sodium hydrogen methylarsonate), sulcotrione, sulfentrazone, sulfometuron, sulfometuron-methyl, sulfosulfuron, swep, TCA (2,2,2-trichloroacetic acid), tebutam, tebuthiuron, tefuryltrione, tembotrione, terbacil, terbumeton, terbuthylazine, terbutryn, thaxtomin A, thenylchlor, thiazopyr, thidiazimin, thiencarbazone, thiencarbazone-methyl, thifensulfuron, thifensulfuron-methyl, tiafenacil, tiocarbazil, tolpyralate, topramezone, tralkoxydim, triafamone, tri-allate, triasulfuron, triaziflam, tribenuron, tribenuron-methyl, triclopyr, triclopyr-butotyl, triclopyr-ethyl, triclopyr-triethylammonium, tridiphane, trietazine, trifloxysulfuron, trifloxysulfuronsodium salt, trifludimoxazin, trifluralin, triflusulfuron, triflusulfuron-methyl, tritosulfuron, vernolate, 2-chloro-N-(1-methyl-1H-tetrazol-5-yl)-3-(methylthio)-4-(trifluoromethyl)benzamide (1361139-71-0), 4-(4-fluorophenyl)-6-[(2-hydroxy-6-oxo-1-cyclohexen-1-yl)carbonlyl-2-methyl-1,2,4-triazine-3,5(2H,4H)-dione (1353870-34-4), (3S,4S)—N-(2-fluorophenyl)-1-methyl-2-oxo-4-[3-(trifluoromethyl)phenyl]-3-prolidine carboxamide (2053901-33-8), and ethyl [(3-{2-chloro-4-fluoro-5-[3-methyl-4-(trifluoromethyl)-2,6-dioxo-1,2,3,6-tetrahydropyrimidin-1-yl]phenoxy}pyridin-2-yl)oxylacetate (353292-31-6, referred as Compound X hereafter).

Safener: allidochlor, benoxacor, cloquintocet, cloquintocet-mexyl, cyometrinil, cyprosulfamide, dichlormid, dicyclonone, dimepiperate, disulfoton, daiymuron, fenchlorazole, fenchlorazole-ethyl, fenclorim, flurazole, furilazole, fluxofenim, hexim, isoxadifen, isoxadifen-ethyl, mecoprop, mefenpyr, mefenpyr-ethyl, mefenpyr-diethyl, mephenate, metcamifen, oxabetrinil, 1,8-naphthalic anhydride, 1,8-octamethylene diamine, AD-67 (4-(dichloroacetyl)-1-oxa-4-azaspiro[4.5]decane), MCPA (2-(4-chloro-2-methylphenoxy)acetic acid), CL-304415 (4-carboxy-3,4-dihydro-2H-1-benzopyran-4-acetic acid), CSB (1-bromo-4-[(chloromethyl)sulfonyl]benzene), DKA-24 (2,2-dichloro-N-[2-oxo-2-(2-propenylamino)ethyl]-N-(2-propenyl)acetamide), MG191 (2-(dichloromethyl)-2-methyl-1,3-dioxolane), MG-838 (2-propenyl 1-oxa-4-azaspiro[4.5]decane-4-carbodithioate), PPG-1292 (2,2-dichloro-N-(1,3-dioxan-2-ylmethyl)-N-(2-propenyl)acetamide), R-28725 (3-(dichloroacetyl)-2,2-dimethyl-1,3-oxazolidine), R-29148 (3-(dichloroacetyl)-2,2,5-trimethyl-1,3-oxazolidine), and TI-35 (1-(dichloroacetyl)azepane).

Plant growth regulator: hymexazol, paclobutrazol, uniconazole, uniconazole-P, inabenfide, prohexadione-calcium, 1-methylcyclopropene, and trinexapac.

As the herbicide which may be used in combination with the compound of the present invention, saflufenacil, flumioxazin, trifludimoxazin, Compound X, glyphosate potassium salt, glyphosate dimethylamine salt, glyphosate monoethanolamine salt, glufosinate ammonium salt, glyphosate isopropylammonium salt, flumiclorac-pentyl, lactofen, S-metolachlor, metribuzin, flufenacet, nicosulfuron, rimsulfuron, acetochlor, mesotrione, isoxaflutole, chlorimuron-ethyl, thifensulfuron-methyl, cloransulam-methyl, and imazethapyr-ammonium salt, 2,4-D choline, Dicamba-diglycol amine, Dicamba-BAPMA salt, Dicamba-TBA salt, and Dicamba-TBP salt are particularly preferable. When Compound X is used in combination as a crystal form, crystalline form written in WO2018178039 is preferred.

Particular combinations of the compound of the present invention with other herbicides are listed, but not limited to, below. The numbers in parentheses are dose rate examples based on grams per 10,000 m². Each of these combinations can be further combined with glyphosate potassium salt or glufosinate ammonium salt. In each of these combinations, Clethodim can be substituted with any other compounds of the present invention such as fluazifop-P-butyl.

Clethodim(70-140)+dicamba diglycolamine salt(280-560 as dicamba)

Clethodim(70-140)+dicamba BAPMA salt(280-560 as dicamba)

Clethodim(70-140)+dicamba TBA salt(280-560 as dicamba)

Clethodim(70-140)+dicamba TBP salt(280-560 as dicamba)

Clethodim(70-140)+flumioxazin (70-210)

Clethodim(70-140)+flumioxazin(70-210)+dicamba diglycolamine salt(280-560 as dicamba)

Clethodim(70-140)+flumioxazin(70-210)+dicamba BAPMA salt(280-560 as dicamba)

Clethodim(70-140)+flumioxazin(70-210)+dicamba TBA salt(280-560 as dicamba)

Clethodim(70-140)+flumioxazin(70-210)+dicamba TBP salt(280-560 as dicamba)

Clethodim(70-140)+mesotrione(105-210)

Clethodim(70-140)+mesotrione(105-210)+dicamba diglycolamine salt(280-560 as dicamba)

Clethodim(70-140)+mesotrione(105-210)+dicamba BAPMA salt(280-560 as dicamba)

Clethodim(70-140)+mesotrione(105-210)+dicamba TBA salt(280-560 as dicamba)

Clethodim(70-140)+mesotrione(105-210)+dicamba TBP salt(280-560 as dicamba)

Clethodim(70-140)+flumioxazin(70-210)+mesotrione(105-210)

Clethodim(70-140)+flumioxazin(70-210)+mesotrione(105-210)+dicamba diglycolamine salt(280-560 as dicamba)

Clethodim(70-140)+flumioxazin(70-210)+mesotrione(105-210)+dicamba BAPMA salt(280-560 as dicamba)

Clethodim(70-140)+flumioxazin(70-210)+mesotrione(105-210)+dicamba TBA salt(280-560 as dicamba)

Clethodim(70-140)+flumioxazin(70-210)+mesotrione(105-210)+dicamba TBP salt(280-560 as dicamba)

Clethodim(70-140)+isoxaflutole(70-140)

Clethodim(70-140)+isoxaflutole(70-140)+dicamba diglycolamine salt(280-560 as dicamba)

Clethodim(70-140)+isoxaflutole(70-140)+dicamba BAPMA salt(280-560 as dicamba)

Clethodim(70-140)+isoxaflutole(70-140)+dicamba TBA salt(280-560 as dicamba)

Clethodim(70-140)+isoxaflutole(70-140)+dicamba TBP salt(280-560 as dicamba)

Clethodim(70-140)+flumioxazin(70-210)+isoxaflutole(70-140)

Clethodim(70-140)+flumioxazin(70-210)+isoxaflutole(70-140)+dicamba diglycolamine salt(280-560 as dicamba)

Clethodim(70-140)+flumioxazin(70-210)+isoxaflutole(70-140)+dicamba BAPMA salt(280-560 as dicamba)

Clethodim(70-140)+flumioxazin(70-210)+isoxaflutole(70-140)+dicamba TBA salt(280-560 as dicamba)

Clethodim(70-140)+flumioxazin(70-210)+isoxaflutole(70-140)+dicamba TBP salt(280-560 as dicamba)

Clethodim(70-140)+metribuzin(560-840)+acetochlor(1000-2000)

Clethodim(70-140)+acetochlor(1000-2000)+dicamba diglycolamine salt(280-560 as dicamba)

Clethodim(70-140)+acetochlor(1000-2000)+dicamba TBA salt(280-560 as dicamba)

Clethodim(70-140)+acetochlor(1000-2000)+dicamba TBP salt(280-560 as dicamba)

Clethodim(70-140)+flumioxazin(70-210)+pyroxasulfone(90-210)

Clethodim(70-140)+flumioxazin(70-210)+pyroxasulfone(90-210)+dicamba diglycolamine salt(280-560 as dicamba)

Clethodim(70-140)+flumioxazin(70-210)+pyroxasulfone(90-210)+dicamba BAPMA salt(280-560 as dicamba)

Clethodim(70-140)+flumioxazin(70-210)+pyroxasulfone(90-210)+dicamba TBA salt(280-560 as dicamba)

Clethodim(70-140)+flumioxazin(70-210)+pyroxasulfone(90-210)+dicamba TBP salt(280-560 as dicamba)

Clethodim(70-140)+flumioxazin(70-210)+pyroxasulfone(90-210)+mesotrione(105-210)

Clethodim(70-140)+flumioxazin(70-210)+pyroxasulfone(90-210)+mesotrione(105-210)+dicamba diglycolamine salt(280-560 as dicamba)

Clethodim(70-140)+flumioxazin(70-210)+pyroxasulfone(90-210)+mesotrione(105-210)+dicamba BAPMA salt(280-560 as dicamba)

Clethodim(70-140)+flumioxazin(70-210)+pyroxasulfone(90-210)+mesotrione(105-210)+dicamba TBA salt(280-560 as dicamba)

Clethodim(70-140)+flumioxazin(70-210)+pyroxasulfone(90-210)+mesotrione(105-210)+dicamba TBP salt(280-560 as dicamba)

Clethodim(70-140)+flumioxazin(70-210)+pyroxasulfone(90-210)+isoxaflutole(70-140)

Clethodim(70-140)+flumioxazin(70-210)+pyroxasulfone(90-210)+isoxaflutole(70-140)+dicamba diglycolamine salt(280-560 as dicamba)

Clethodim(70-140)+flumioxazin(70-210)+pyroxasulfone(90-210)+isoxaflutole(70-140)+dicamba BAPMA salt(280-560 as dicamba)

Clethodim(70-140)+flumioxazin(70-210)+pyroxasulfone(90-210)+isoxaflutole(70-140)+dicamba TBA salt(280-560 as dicamba)

Clethodim(70-140)+flumioxazin(70-210)+pyroxasulfone(90-210)+isoxaflutole(70-140)+dicamba TBP salt(280-560 as dicamba)

Clethodim(70-140)+dicamba diglycolamine salt(280-560 as dicamba)+Compound X(20-40)

Clethodim(70-140)+dicamba BAPMA salt(280-560 as dicamba)+Compound X(20-40)

Clethodim(70-140)+dicamba TBA salt(280-560 as dicamba)+Compound X(20-40)

Clethodim(70-140)+dicamba TBP salt(280-560 as dicamba)+Compound X(20-40)

Clethodim(70-140)+flumioxazin (70-210)+Compound X(20-40)

Clethodim(70-140)+flumioxazin(70-210)+dicamba diglycolamine salt(280-560 as dicamba)+Compound X(20-40)

Clethodim(70-140)+flumioxazin(70-210)+dicamba BAPMA salt(280-560 as dicamba)+Compound X(20-40)

Clethodim(70-140)+flumioxazin(70-210)+dicamba TBA salt(280-560 as dicamba)+Compound X(20-40)

Clethodim(70-140)+flumioxazin(70-210)+dicamba TBP salt(280-560 as dicamba)+Compound X(20-40)

Clethodim(70-140)+mesotrione(105-210)+Compound X(20-40)

Clethodim(70-140)+mesotrione(105-210)+dicamba diglycolamine salt(280-560 as dicamba)+Compound X(20-40)

Clethodim(70-140)+mesotrione(105-210)+dicamba BAPMA salt(280-560 as dicamba)+Compound X(20-40)

Clethodim(70-140)+mesotrione(105-210)+dicamba TBA salt(280-560 as dicamba)+Compound X(20-40)

Clethodim(70-140)+mesotrione(105-210)+dicamba TBP salt(280-560 as dicamba)+Compound X(20-40)

Clethodim(70-140)+flumioxazin(70-210)+mesotrione(105-210)+Compound X(20-40)

Clethodim(70-140)+flumioxazin(70-210)+mesotrione(105-210)+dicamba diglycolamine salt(280-560 as dicamba)+Compound X(20-40)

Clethodim(70-140)+flumioxazin(70-210)+mesotrione(105-210)+dicamba BAPMA salt(280-560 as dicamba)+Compound X(20-40)

Clethodim(70-140)+flumioxazin(70-210)+mesotrione(105-210)+dicamba TBA salt(280-560 as dicamba)+Compound X(20-40)

Clethodim(70-140)+flumioxazin(70-210)+mesotrione(105-210)+dicamba TBP salt(280-560 as dicamba)+Compound X(20-40)

Clethodim(70-140)+isoxaflutole(70-140)+Compound X(20-40)

Clethodim(70-140)+isoxaflutole(70-140)+dicamba diglycolamine salt(280-560 as dicamba)+Compound X(20-40)

Clethodim(70-140)+isoxaflutole(70-140)+dicamba BAPMA salt(280-560 as dicamba)+Compound X(20-40)

Clethodim(70-140)+isoxaflutole(70-140)+dicamba TBA salt(280-560 as dicamba)+Compound X(20-40)

Clethodim(70-140)+isoxaflutole(70-140)+dicamba TBP salt(280-560 as dicamba)+Compound X(20-40)

Clethodim(70-140)+flumioxazin(70-210)+isoxaflutole(70-140)+Compound X(20-40)

Clethodim(70-140)+flumioxazin(70-210)+isoxaflutole(70-140)+dicamba diglycolamine salt(280-560 as dicamba)+Compound X(20-40)

Clethodim(70-140)+flumioxazin(70-210)+isoxaflutole(70-140)+dicamba BAPMA salt(280-560 as dicamba)+Compound X(20-40)

Clethodim(70-140)+flumioxazin(70-210)+isoxaflutole(70-140)+dicamba TBA salt(280-560 as dicamba)+Compound X(20-40)

Clethodim(70-140)+flumioxazin(70-210)+isoxaflutole(70-140)+dicamba TBP salt(280-560 as dicamba)+Compound X(20-40)

Clethodim(70-140)+metribuzin(560-840)+acetochlor(1000-2000)+Compound X(20-40)

Clethodim(70-140)+acetochlor(1000-2000)+dicamba diglycolamine salt(280-560 as dicamba)+Compound X(20-40)

Clethodim(70-140)+acetochlor(1000-2000)+dicamba TBA salt(280-560 as dicamba)+Compound X(20-40)

Clethodim(70-140)+acetochlor(1000-2000)+dicamba TBP salt(280-560 as dicamba)+Compound X(20-40)

Clethodim(70-140)+flumioxazin(70-210)+pyroxasulfone(90-210)+Compound X(20-40)

Clethodim(70-140)+flumioxazin(70-210)+pyroxasulfone(90-210)+dicamba diglycolamine salt(280-560 as dicamba)+Compound X(20-40)

Clethodim(70-140)+flumioxazin(70-210)+pyroxasulfone(90-210)+dicamba BAPMA salt(280-560 as dicamba)+Compound X(20-40)

Clethodim(70-140)+flumioxazin(70-210)+pyroxasulfone(90-210)+dicamba TBA salt(280-560 as dicamba)+Compound X(20-40)

Clethodim(70-140)+flumioxazin(70-210)+pyroxasulfone(90-210)+dicamba TBP salt(280-560 as dicamba)+Compound X(20-40)

Clethodim(70-140)+flumioxazin(70-210)+pyroxasulfone(90-210)+mesotrione(105-210)+Compound X(20-40)

Clethodim(70-140)+flumioxazin(70-210)+pyroxasulfone(90-210)+mesotrione(105-210)+dicamba diglycolamine salt(280-560 as dicamba)+Compound X(20-40)

Clethodim(70-140)+flumioxazin(70-210)+pyroxasulfone(90-210)+mesotrione(105-210)+dicamba BAPMA salt(280-560 as dicamba)+Compound X(20-40)

Clethodim(70-140)+flumioxazin(70-210)+pyroxasulfone(90-210)+mesotrione(105-210)+dicamba TBA salt(280-560 as dicamba)+Compound X(20-40)

Clethodim(70-140)+flumioxazin(70-210)+pyroxasulfone(90-210)+mesotrione(105-210)+dicamba TBP salt(280-560 as dicamba)+Compound X(20-40)

Clethodim(70-140)+flumioxazin(70-210)+pyroxasulfone(90-210)+isoxaflutole(70-140)+Compound X(20-40)

Clethodim(70-140)+flumioxazin(70-210)+pyroxasulfone(90-210)+isoxaflutole(70-140)+dicamba diglycolamine salt(280-560 as dicamba)+Compound X(20-40)

Clethodim(70-140)+flumioxazin(70-210)+pyroxasulfone(90-210)+isoxaflutole(70-140)+dicamba BAPMA salt(280-560 as dicamba)+Compound X(20-40)

Clethodim(70-140)+flumioxazin(70-210)+pyroxasulfone(90-210)+isoxaflutole(70-140)+dicamba TBA salt(280-560 as dicamba)+Compound X(20-40)

Clethodim(70-140)+flumioxazin(70-210)+pyroxasulfone(90-210)+isoxaflutole(70-140)+dicamba TBP salt(280-560 as dicamba)+Compound X(20-40)

Clethodim(70-140)+Compound X(20-40)

As the safener which may be used in combination with the compound of the present invention, cyprosulfamide, benoxacor, dichlormid, and furilazole are particularly preferable.

When the above herbicide and/or safener are used in combination with the compound of the present invention, the ratio of the compound of the present invention to the above herbicide/safener is usually 1:0.001 to 100, preferably 1:0.01 to 1:10 times, more preferably 1:0.1 to 1:5, further preferably 1:0.2, 1:0.4, 1:0.6, 1:0.8, 1:1, 1:1.5, 1:2, 1:2.5, 1:3, and 1:4 times. These rations can be described with “about”. “About” means plus/minus 10%. So, for example, about 1:2 means 1:1.8 to 1:2.2.

In dicot crop cultivation in the present invention, dicot crop nutritional control made in usual dicot crop cultivation can be applied. The fertilizing system may be either one based on Precision Agriculture or traditionally uniform one. Also, nitrogen fixation bacteria and mycorrhizal fungi may be inoculated in combination with seed treatment with the compound group A.

In the cultivation of dicot crops of the present invention, it is possible to perform typical plant nutrition management on dicot crop cultivation. The fertilization system may be a system based on Precision Agriculture or a uniform system which has been practically used. Further, nitrogen-fixing bacteria or mycorrhizal fungi may be inoculated to dicot crop seeds together with the treatment applied to the dicot crop seeds with the compound group A.

### EXAMPLES

Hereinafter, the present invention will be described in detail with reference to examples, but the present invention is not limited thereto.

First, the evaluation criteria of the herbicidal effects, and the phytotoxicity on dicot crops, shown in the following examples, will be described.

Herbicidal Effects

In the evaluation of the herbicidal effects, when the sprouting or growing state of the test corn plants or weeds at the time of investigation is compared to that of corn plants or weeds in an untreated area and there is no difference or almost no difference between the states, this case is evaluated as “0”. Further, when the test corn plants or the weeds are completely withered or sprouting or growing of corn plants or weeds is completely suppressed, this case is evaluated as “100”. The effects are evaluated on a scale of 0 to 100.

Phytotoxicity on Dicot Crops

In the evaluation of phytotoxicity on dicot crops, a case where phytotoxicity is not confirmed is evaluated as “harmless”, a case where mild phytotoxicity is confirmed is evaluated as “small”, a case where moderate phytotoxicity is confirmed is evaluated as “medium”, and a case where strong phytotoxicity is confirmed is evaluated as “large”.

### Example 1

Soybean seeds (cultivar. Genuity RoundupReady 2 Xtend) are sown in a field where PPO inhibitor tolerant corn seeds having mutated PPO exist. When soybean crop reach 3 trifoliate leaf stage, SelectMax (120 g/L of clethodim manufactured by Valent), Roundup PowerMax (660 g/L of glyphosate potassium salt, manufactured by Monsanto Company), XtendiMax (350 g/L of dicamba as a form of diglycolamine salt) are diluted with water in a tank, and the emerged PPO tolerant volunteer corn plants reaching 4 leaf stage are treated such that the treatment amounts are set to 9 fluid ounces/acre (fl. oz/A) of SelectMax+32 fl. oz/A of Roundup PowerMax+22 fl. oz/A of XtendiMax.

### Example 2

PPO inhibitor tolerant soybean seeds having mutated PPO that are also tolerant to glyphosate, HPPD inhibitor, and dicamba are sown in a field where PPO inhibitor tolerant corn seeds having mutated PPO that are also tolerant to glyphosate and fluazifop-P-ethyl exist. When soybean crop reach 3 trifoliate leaf stage, SelectMax (120 g/L of clethodim manufactured by Valent), Roundup PowerMax (660 g/L of glyphosate potassium salt, manufactured by Monsanto Company), XtendiMax (350 g/L of dicamba as a form of diglycolamine salt) and compound X are diluted with water in a tank, and the emerged PPO tolerant volunteer corn plants reaching 4 leaf stage are treated such that the treatment amounts are set to 12 fluid ounces/acre (fl. oz/A) of SelectMax+32 fl. oz/A of Roundup PowerMax+22 fl. oz/A of XtendiMax+20 g/ha of Compound X.

### INDUSTRIAL APPLICABILITY

According to the method of the present invention, volunteer corn plants tolerant to PPO inhibiting herbicides in a cultivation area of dicot crops can be controlled.

1. A method for controlling volunteer corn plants tolerant to protoporphyrinogen oxidase (PPO) inhibiting herbicides in a cultivation area of a dicot crop, comprising:
applying an Acetyl-CoA carboxylase (ACCase) inhibiting herbicide to the corn plants.

2. The method according to claim 1, wherein the dicot crop is tolerant to PPO-inhibiting herbicides.

3. The method according to claim 1, wherein the dicot crop is soybean or cotton.

4. The method according to claim 1, wherein the ACCase inhibiting herbicide is selected from the group consisting of clethodim, sethoxydim, tepraloxydim, fluazifop or its ester, fluiazifop-P or its ester, quizalofop or its ester, quizalofop-P or its ester, haloxyfop or its ester, and haloxyfop-P or its ester.

5. The method according to claim 1, wherein the ACCase inhibiting herbicide is applied with a PPO-inhibiting herbicide optionally with one or more different herbicides.

6. The method according to claim 5, further comprising:
applying a PPO-inhibiting herbicide selected from the group consisting of flumioxazin, trifludimoxazin, saflufenacil, fomesafen or its salt, lactofen, and ethyl [3-[2-chloro-4-fluoro-5-(1-methyl-6-trifluoromethyl-2,4-dioxo-1,2,3,4-tetrahydropyrimidine-3-yl)phenoxy]-2-pyridyloxy]acetate.

7. The method according to claim 2, wherein the dicot crop is soybean or cotton.

8. The method according to claim 2, wherein the ACCase inhibiting herbicide is selected from the group consisting of clethodim, sethoxydim, tepraloxydim, fluazifop or its ester, fluiazifop-P or its ester, quizalofop or its ester, quizalofop-P or its ester, haloxyfop or its ester, and haloxyfop-P or its ester.

9. The method according to claim 3, wherein the ACCase inhibiting herbicide is selected from the group consisting of clethodim, sethoxydim, tepraloxydim, fluazifop or its ester, fluiazifop-P or its ester, quizalofop or its ester, quizalofop-P or its ester, haloxyfop or its ester, and haloxyfop-P or its ester.

10. The method according to claim 2, wherein the ACCase inhibiting herbicide is applied with a PPO-inhibiting herbicide optionally with one or more different herbicides.

11. The method according to claim 3, wherein the ACCase inhibiting herbicide is applied with a PPO-inhibiting herbicide optionally with one or more different herbicides.

12. The method according to claim 4, wherein the ACCase inhibiting herbicide is applied with a PPO-inhibiting herbicide optionally with one or more different herbicides.
